(19) United States
(12) Patent Application Publication
(10) Pub. No.: US 2025/0133399 A1
(43) Pub. Date: Apr. 24, 2025

(54) APPLICATION PROGRAMMING INTERFACE (API) ACCESS MANAGEMENT IN WIRELESS SYSTEMS

(71) Applicant: Lenovo (Singapore) Pte. Limited, Singapore (SG)

(72) Inventors: Sheeba Backia Mary Baskaran, Friedrichsdorf (DE); Andreas Kunz, Ladenburg (DE)

(73) Assignee: Lenovo (Singapore) Pte. Limited, Singapore (SG)

(21) Appl. No.: 18/833,248

(22) PCT Filed: Jan. 13, 2023
(86) PCT No.: PCT/IB2023/050342

§ 371 Date: Jul. 25, 2024

Related U.S. Application Data
(60) Provisional application No. 63/304,229, filed on Jan. 28, 2022.

(51) Int. Cl. H04W 12/06; H04W 8/18

(52) U.S. Cl. CPC H04W 12/06; H04W 8/18

(57) ABSTRACT

The present disclosure relates to methods, apparatuses, and systems that support API access management in wireless systems. For instance, an API invoker (e.g., a user or UE) can be authenticated and authorized to access or register with a common API framework (CAPIF) function to enable real-time user consent driven API invocation authorization and secured user service data exposure by a network. Further, a comprehensive set of procedures are provided that ensure that networks are protected from unpermitted and/or potentially malicious access to APIs exposed by the network.

### RELATED APPLICATION

This application claims priority to U.S. Provisional Patent Application Ser. No. 63/304,229 filed Jan. 28, 2022 entitled “API ACCESS MANAGEMENT IN WIRELESS SYSTEMS,” the disclosure of which is incorporated by reference herein in its entirety.

### TECHNICAL FIELD

The present disclosure relates to wireless communications, and more specifically to using APIs in wireless systems.

### BACKGROUND

A wireless communications system may include one or multiple network communication devices, such as base stations, which may be otherwise known as an eNodeB (eNB), a next-generation NodeB (gNB), or other suitable terminology and core network functions. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

Some wireless system specifications detail techniques for access to application programming interfaces (APIs) that can provide functionality to UEs, such as to enable various tasks to be performed by APIs on behalf of UEs. For instance, such specifications include architectures and signaling for wireless networks to expose APIs for invoking functions on behalf of UEs.

### SUMMARY

The present disclosure relates to methods, apparatuses, and systems that support API access management in wireless systems. For instance, an API invoker (e.g., a user or UE) can be authenticated and authorized to access or register with a common API framework (CAPIF) function to enable real-time user consent driven API invocation authorization and secured user service data exposure by a network. Further, a comprehensive set of procedures are provided that ensure that networks are protected from unpermitted and/or potentially malicious access to APIs exposed by the network.

By utilizing the described techniques, a UE/API invoker is enabled to securely register with a wireless network to invoke APIs managed and/or exposed by the wireless network. For instance, to maintain security, a UE (e.g., an application/service/client of the UE, the UE itself or an application server related to the application in the UE) is able to initiate an onboarding enrollment with an API provider domain of a wireless network followed by onboarding with a CAPIF core function (CCF) associated with the wireless network. The onboarding provides the UE with access credentials for accessing an API exposing function (AEF) of the wireless network for invoking APIs. Accordingly, the UE/API invoker can interact with the AEF using the access credentials to invoke functionality of APIs exposed by the AEF. By performing the described techniques, a UE/API invoker is able to initiate API access registration while protecting sensitive data on the UE. Further, the described techniques mitigate the possibility of unpermitted and/or malicious access to API functionality of a wireless network by untrusted UEs/API invokers.

Some implementations of the method and apparatuses described herein may include wireless communication at a device (e.g., at a UE), which includes generating an enrollment request requesting enrollment for onboarding with a CCF of a wireless network, the enrollment request including a UE identifier for the apparatus, sending, to an API provider domain of the wireless network, the enrollment request, receiving an enrollment response that includes enrollment data including key data associated with the CCF of the wireless network, and storing the enrollment data for use by the apparatus to perform an onboarding procedure for onboarding one or more of the apparatus or an application related to the apparatus with the CCF of the wireless network to enable the apparatus to invoke one or more APIs exposed by the API provider domain.

In addition, some implementations of the method and apparatuses described herein may include wireless communication at a device (e.g., at a UE), which includes receiving, from an API invoker, an enrollment request requesting enrollment for onboarding with a CCF of a wireless network, the enrollment request including a UE identifier for the API invoker, sending, to an authentication function of the wireless network, an authentication/authorization request that includes the UE identifier and a CCF identifier for the CCF of the wireless network, receiving, from the authentication entity, an authentication/authorization response including key data for the CCF of the wireless network, and sending, to the API invoker, an enrollment response that includes an indication that the API invoker is successfully enrolled for onboarding with the CCF of the wireless network, a key data identifier, and the key data for the CCF of the wireless network.

In addition, some implementations of the method and apparatuses described herein may include wireless communication at a device (e.g., at a UE), which includes receiving an authentication/authorization request for authenticating/authorizing an API invoker to onboard with a CCF of a wireless network, the authentication/authorization request including a UE identifier for the API invoker and a CCF identifier for the CCF of the wireless network, deriving, based on the CCF identifier, key data for the CCF of the wireless network, generating an authentication/authorization response that indicates that the API invoker is authorized for onboarding with the CCF of the wireless network and that includes the key data for the CCF of the wireless network, and sending, to an API provider domain of the wireless network, the authentication/authorization response.

In addition, some implementations of the method and apparatuses described herein may include wireless communication at a device (e.g., at a UE), which includes generating an enrollment request requesting enrollment for onboarding with a CCF of a wireless network, the enrollment request including a UE identifier for the apparatus, sending, to an API provider domain of the wireless network, the enrollment request, receiving an enrollment response that includes enrollment data including key data associated with the CCF of a wireless network, and storing the enrollment data for use by the apparatus to perform an onboarding procedure for onboarding one or more of the apparatus or an application related to the apparatus with the CCF of the wireless network to enable the apparatus to invoke one or more APIs exposed by the API provider domain.

In addition, some implementations of the method and apparatuses described herein may include wireless communication at a device (e.g., at a UE), which includes obtaining an AEF key associated with an AEF of a wireless network, sending an authentication initiation request to the AEF, the authentication initiation request including an API invoker identifier and a UE identifier for the apparatus, receiving an authentication initiation response from the AEF, and establish a secure connection with the AEF using the AEF key, send, over the secure connection, a service invocation request to the AEF, the service invocation request including one or more of: UE identifier, an access token, or an API request identifying an API to be invoked, and receiving, over the secure connection and from the AEF, a service invocation response indicating a result of the API request.

In addition, some implementations of the method and apparatuses described herein may include wireless communication at a device (e.g., at a core network component), which includes receiving, from an API invoker, an authentication initiation request, the authentication initiation request including an API invoker identifier and a UE identifier associated with the API invoker, sending, to the API invoker, an authentication initiation response and establish a secure connection with the API invoker using an AEF key, receiving, over the secure connection and from the API invoker, a service invocation request, the service invocation request including one or more of: UE identifier, an access token, or an API request identifying an API to be invoked, causing an API invocation action based on the API request, and sending, over the secure connection and to the API invoker, a service invocation response indicating a result of the API invocation action.

### BRIEF DESCRIPTION OF THE DRAWINGS

Various aspects of the present disclosure for API access management in wireless systems are described with reference to the following Figures. The same numbers may be used throughout to reference like features and components shown in the Figures.

FIG. 1 illustrates an example of a wireless communications system that supports API access management in wireless systems in accordance with aspects of the present disclosure.

FIG. 2 illustrates an example of a CAPIF system that supports API access management in wireless systems in accordance with aspects of the present disclosure.

FIG. 3 illustrates an example API invoker onboarding enrollment procedure that supports API access management in wireless systems in accordance with aspects of the present disclosure.

FIG. 4 illustrates an example API invoker onboarding procedure that supports API access management in wireless systems in accordance with aspects of the present disclosure.

FIG. 5 illustrates an example security method selection procedure that supports API access management in wireless systems in accordance with aspects of the present disclosure.

FIG. 6 illustrates an example API invocation procedure that supports API access management in wireless systems in accordance with aspects of the present disclosure.

FIG. 7 illustrates an example block diagram of components of a device (e.g., a UE) that supports API access management in wireless systems in accordance with aspects of the present disclosure.

FIG. 8 illustrates an example block diagram of components of a device (e.g., a core network component) that supports API access management in wireless systems in accordance with aspects of the present disclosure.

FIGS. 9-21 illustrate flowcharts of methods that support API access management in wireless systems in accordance with aspects of the present disclosure.

### DETAILED DESCRIPTION

Implementations of API access management in wireless systems are described, such as related to enabling a UE/API invoker to securely register with a wireless network to invoke APIs managed and/or exposed by the wireless network. For instance, a UE (e.g., an application/service/client of the UE, the UE itself or an application server related to the application in the UE) is able to initiate an onboarding enrollment with an API provider domain of a wireless network followed by onboarding with a CCF associated with the wireless network. The onboarding provides the UE with access credentials for accessing an AEF of the wireless network for invoking APIs. Accordingly, the UE/API invoker can interact with the AEF using the access credentials to invoke functionality of APIs exposed by the AEF.

Some wireless network architectures propose to enable API services to be provided to UEs. However, some of these architectures do not provide ways to enable a UE to securely register to receive API services from a wireless network, or to securely invoke APIs exposed by a wireless network.

Accordingly, by performing the described techniques, a UE/API invoker is able to initiate API access registration while protecting sensitive data on the UE. Further, the described techniques mitigate the possibility of unpermitted and/or malicious access to API functionality of a wireless network by untrusted UEs/API invokers.

Aspects of the present disclosure are described in the context of a wireless communications system. Aspects of the present disclosure are further illustrated and described with reference to device diagrams and flowcharts that relate to API access management in wireless systems.

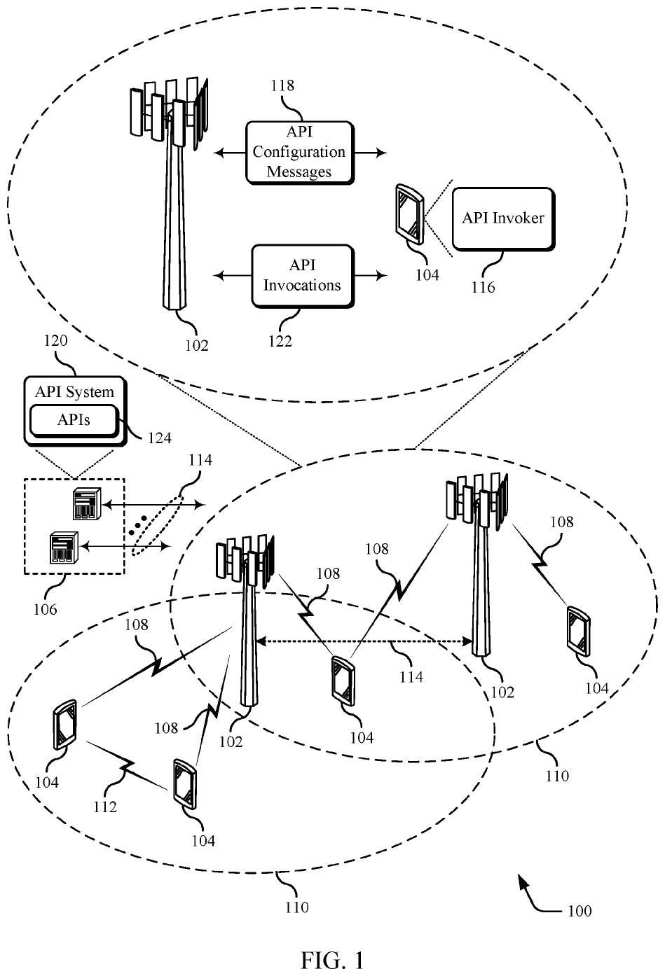

FIG. 1 illustrates an example of a wireless communications system 100 that supports API access management in wireless systems in accordance with aspects of the present disclosure. The wireless communications system 100 may include one or more base stations 102, one or more UEs 104, a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, one or more of the UEs 104 and the core network 106 are operable to implement various aspects of API access management in wireless systems, as described herein. For instance, a UE 104 implements and/or interacts with an API invoker 116 to cause the API invoker 116 to exchange API configuration messages 118 with an API system 120 implemented by the core network 106. For instance, the API invoker 116 and the API system 120 exchange the API configuration messages 118 to configure the API invoker 116 and the API system 120 to enable the API invoker 116 to perform API invocations 122 to invoke APIs 124 exposed and/or managed by the API system 120. Various examples of the API configuration messages 118 and other operations for configuring the API invoker 116 and API system 120 are detailed below.

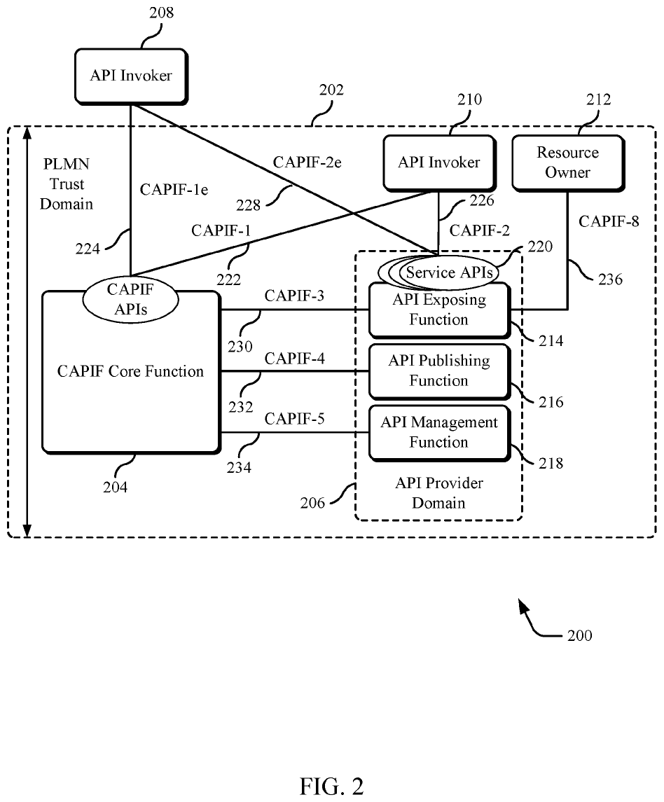

FIG. 2 illustrates an example of a CAPIF system 200 that supports API access management in wireless systems in accordance with aspects of the present disclosure. The CAPIF system 200 may use the wireless communications system 100 and/or be implemented with the wireless communications system. The CAPIF system 200 provides a unified bound API framework across multiple 3^{rd} Generation Partnership Project (3GPP) functions. The CAPIF system 200 hosts APIs of a public land mobile network (PLMN) trust domain 202 and allows third parties to leverage the CAPIF framework to host their APIs.

The CAPIF system 200 includes a CAPIF core function (CCF) 204, an API provider domain 206, one or more API invokers 208 and 210, and a resource owner 212. The resource owner 212 is, for example, a user or a UE. An API invoker can be external to the PLMN trust domain 202 (e.g., API invoker 208) or internal to the PLMN trust domain 202 (e.g., API invoker 210). Each API invoker 208 is an entity (e.g., an application) that requests service from the service providers via the service APIs 220.

The CCF 204 includes one or more of the following capabilities:
Authenticating the API invoker based on the identity and other information required for authentication of the AI invoker;
Supporting mutual authentication with the API invoker;
Providing authorization for the API invoker prior to accessing the service API;
Publishing, storing and supporting the discovery of service APIs information;
Controlling the service API access based on PLMN operator configured policies;
Storing the logs for the service API invocations and providing the service API invocation logs to authorized entities;
Charging based on the logs of the service API invocations;
Monitoring the service API invocations;
Onboarding a new API invoker and offboarding an API invoker;
Storing policy configurations related to CAPIF and service APIs;
Support accessing the logs for auditing (e.g., detecting abuse); and
Supports publishing, discovery of service APIs information with another CAPIF core function in CAPIF interconnection.

The API provider domain 206 includes an AEF 214, an API publishing function 216, and an API management function 218. The AEF 214 is the provider of the service APIs 220 and is also the service communication entry point of the service APIs 220 to the API invokers 208 and 210. The API exposing function includes one or more of the following capabilities: authenticating the API invoker based on the identity and other information required for authentication of the API invoker provided by the CAPIF core function; validating the authorization provided by the CAPIF core function; and logging the service API invocations at the CAPIF core function.

The API publishing function 216 enables the API provider to publish the service APIs information in order to enable the discovery of service APIs by the API invoker. The API publishing function includes the capability of publishing the service CAPIF information of the CAPIF provider to the CAPIF core function.

The API management function 218 enables the API provider to perform administration of the service APIs. The API management function includes one or more of the following capabilities: auditing the service API invocation logs received from the CAPIF core function; monitoring the events reported by the CAPIF core function; configuring the CAPIF provider policies to the CAPIF core function; monitoring the status of the service APIs; onboarding the new API invokers and offboarding API invokers; and registering and maintaining registration information of the API provider domain functions on the CAPIF core function.

The CAPIF system 200 includes multiple reference points, each reference point indicating interactions between two CAPIF functions. These reference points include CAPIF-1 reference point 222, CAPIF-1e reference point 224, CAPIF-2 reference point 226, CAPIF-2e reference point 228, CAPIF-3 reference point 230, CAPIF-4 reference point 232, CAPIF-5 reference point 234, and CAPIF-8 reference point 236.

The CAPIF-1 reference point 222, which exists between the API invoker 210 and the CCF 204, is used for the API invoker 210 within the PLMN trust domain 202 to discover service APIs 220, to authenticate and to get authorization. The CAPIF-1 reference point supports: authenticating the API invoker 210 based on the identity and credentials of the API invoker 210; mutual authentication between the API invoker 210 and the CCF 204; providing authorization for the API invoker 210 prior to accessing the service API 220; and discovering the service APIs 220 information.

The CAPIF-1e reference point 224, which exists between the API invoker 208 and the CCF 204, is used for the API invoker 208 outside the PLMN trust domain 202 to discover service APIs 220, to authenticate and to get authorization. The CAPIF-1e reference point 224 supports all the functions of the CAPIF-1 reference point 222, although for the API invoker 208 rather than the API invoker 210.

The CAPIF-2 reference point 226, which exists between the API invoker 210 and the AEF 214 belonging to the same trust domain, is used for the API invoker 210 to communicate with the service APIs 220. The CAPIF-2 reference point 226 supports: authenticating the API invoker 210 based on the identity and credentials of the API invoker 210; authorization verification for the API invoker 210 upon accessing the service API; and invocation of service APIs 220.

The CAPIF-2e reference point 228, which exists between the API invoker 208 and the AEF 214 belonging to a different trust domain, is used for the API invoker 208 to communicate with the service APIs 220. The CAPIF-2e reference point 228 supports all the functions of CAPIF-2 reference point 226, although for the API invoker 208 rather than the API invoker 210.

The CAPIF-3 reference point 230, which exists between the AEF 214 and the CCF 204, is used for exercising access and policy related control for service API communications initiated by the API invoker (e.g., the API invoker 208 or the API invoker 210). The CAPIF-3 reference point 230 supports: authenticating the API invoker based on the identity and credentials of the API invoker; providing authorization for the API invoker prior to accessing the service API; authorization verification for the API invoker upon accessing the service API 220; controlling the service API 220 access based on PLMN operator configured policies; logging the service API 220 invocations; and charging the service API 220 invocations.

The CAPIF-4 reference point, which exists between the API publishing function 216 and the CCF 204, is used for publishing the service API 220 information. The CAPIF-4 reference point 232 supports publishing the service APIs 220 information by the API publishing function 216.

The CAPIF-5 reference point 234, which exists between the API management function 218 and the CCF, is used for management of service API 220, API invoker (e.g., the API invoker 208 or the API invoker 210) and API provider domain function information. The CAPIF-5 reference point 234 supports: accessing the service API 220 invocation logs by the API management function 218; enabling the API management function 218 to monitor the events reported due to the service APIs 220 invocations; onboarding new API invokers by provisioning the API invoker information at the CCF, requesting explicit grant of new API invokers onboarding and confirming onboarding success; offboarding API invokers; enabling the API management function 218 to configure policies at the CCF e.g. service API invocation throttling, blocking API invocation for certain duration; enabling the API provider to monitor the status of service APIs 220 (e.g. pilot or live status, start or stop status of service API 220); registering API provider domain functions on the CCF; and update of the registration information of API provider domain functions on the CCF.

The CAPIF-8 reference point 236, which exists between the resource owner 212 and the AEF 214, is used for allowing resource owner consent for accepting, providing, or exposing user related data (e.g., resource owner related data) to a service API 220. The CAPIF-8 reference supports: generating CAPIF keys for the resource owner 212 CAPIF authentication and authorization; registering the resource owner 212 for CAPIF authentication and authorization; and performing user consent collection upon API invocation.

In some wireless systems, existing API invoker onboarding procedure utilizes an onboarding enrollment information as a prerequisite. However, methods of enrolment and methods to generate the enrollment information including the authentication information (e.g., access token generation) is not defined and left out of scope. In such systems, UE-originated API invocation may use different implementations of onboarding enrollment that can cause UE compatibility issues. Further, in some wireless systems the API invoker onboarding procedure does not allow the CCF to authenticate a UE (e.g., resource owner) from which an API invocation is originated. Further, there is no explicit client and resource owner authentication, and the existing onboarding procedure establishes security based on TLS (Server-side certificate authentication). Thus, some wireless systems don't support explicit Resource-owner, UE, and/or user authentication for onboarding.

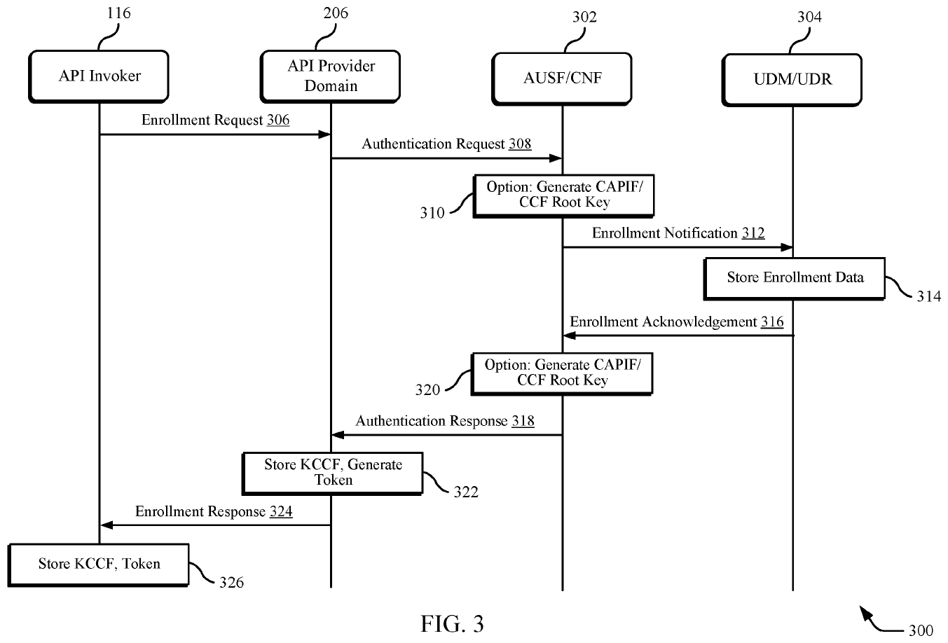

FIG. 3 illustrates an example API invoker onboarding enrollment procedure 300 that supports API access management in wireless systems in accordance with aspects of the present disclosure. The onboarding enrollment procedure 300 may implement or be implemented by aspects of the wireless communications system 100. To establish a secure session between an API invoker and the CCF during onboarding, the API invoker either directly, via a UE, or the UE itself implemented the onboarding enrolment procedure 300 to fetch a set of enrollment credentials to authenticate the API invoker and to secure a subsequent onboarding procedure. As described herein an API invoker can represent various entities such as an application in a UE, a client in a UE, an application function serving a UE, an instance of a UE, and so forth.

The onboarding enrollment procedure 300 involves an API invoker 116, an API provider domain 206, an Authentication Server Function/Core Network Function (AUSF/CNF) 302, and a Unified Data Management/Unified Data Repository (UDM/UDR) 304. The AUSF/CNF 302 and the UDM/UDR 304, for instance, are implemented by the core network 106. In at least one implementation, the onboarding enrollment procedure 300 is performed after registration of the API invoker 116 and/or an associated UE with a wireless network. Accordingly, as part of the onboarding enrollment procedure 300, the API invoker 116 generates an enrollment request 306 and communicates the enrollment request 306 to the API provider domain 206. The API invoker 116, for instance, can send the enrollment request to a network function (e.g., core network function such as an AEF, an API publishing function, an API management function, etc.) in the API provider domain 206. The enrollment request 306 includes various data including API invoker IDs such as Application Identifiers (A-IDs), Application Function Identifiers (AF-IDs), UE ID, and user consent information attributes for one or more API service(s). A UE ID can be implemented in various ways such as a Generic Public Subscription Identifier (GPSI), a Subscription Permanent Identifier (SUPI), a UE Internet Protocol (IP) address, a UE ethernet address, a UE external group ID, a CAPIF-UE ID, and so forth.

The API provider domain 206 receives the enrollment request 306 and determines based on data in the enrollment request 306 whether UE context data is available (e.g., a UE authentication result, resource owner registration information, etc.) and identifies a UE such as based on the SUPI. Further, based on an A-ID(s) and/or AF-ID(s) and operator local policy for an associated network, the API provider domain 206 may check if the A-ID(s) and/or AF-ID(s) are allowed to consume service APIs and/or perform API invocation from the network. If the API provider domain 206 determines to allow the enrollment request 306 (e.g., based on the SUPI), the API provider domain 206 generates an enrollment authentication request 308 and sends the authentication request 308 to the AUSF/CNF 302. The authentication request 308 can include various data such as the received API invoker IDs, e.g., A-IDs, AF-IDs, user consent information attributes for one or more service(s), SUPI, API provider domain ID, and CCF ID, CCF address, and so forth. Alternatively or additionally, if the API provider domain 206 receives the UE GPSI, then the related SUPI is fetched from the UDM 304 and the authentication request 308 is generated and sent to the AUSF/CNF 302. As another alternative or additional implementation, after receiving the enrollment request 306, the API provider domain 206 identifies a SUPI corresponding to the received UE ID.

The AUSF/CNF 302 receives the authentication request 308, determines whether UE context data is available (e.g., a primary authentication result as success) and/or security context data related to the SUPI, and according to option 310 the AUSF/CNF 302 determines to derive and provide CAPIF root security key/context (K_{CCF}) for the API invoker 116. The AUSF/CNF 302, for instance, derives K_{CCF} from a most recent AUSF key (K_{AUSF}) and/or a CAPIF key (K_{CAPIF}) and a key derivation function (KDF) using input parameters such as UE ID, API provider domain 206 ID, CCF ID, A-ID, AF-ID, a CCF security code, and so forth. In at least one implementation K_{CAPIF} is generated using a KDF with the key K_{AUSF} or an Authentication and Key Management for Applications Key (K_{AKMA}) and input parameters such as UE ID (e.g., SUPI), CAPIF Security Code, etc. As some alternative or additional implementations for option 310:
If the K_{CCF} is to be derived from K_{CAPIF}, then K_{CAPIF} is to be derived from K_{AUSF} or K_{AKMA}.
The AUSF/CNF 302 can derive K_{CCF} from a most recent K_{AKMA} available using KDF and input parameters such as UE ID, APF-ID, AEF ID, CCF ID, A-IDs/AF-IDs, CCF security code, etc.
The AUSF/CNF 302 can provide the K_{CAPIF} as a root CAPIF key to the API provider domain 206.
K_{CAPIF} can be referred as a UE CAPIF Key and/or a Resource Owner Key.

Further to the onboarding enrollment procedure 300, the AUSF/CNF 302 generates an enrollment notification 312 and sends the enrollment notification 312 to the UDM/UDR 304. The enrollment notification 312 includes data such as A-IDs, AF-IDs, user consent information attributes for one or more service(s), SUPI, CCF ID, CCF address, etc. At 314 the UDM/UDR 304 based on SUPI stores enrollment data such as the user consent information attributes for one or more service(s), the CCF ID and/or CCF address, along with related A-IDs and/or AF-IDs, respectively.

The UDM/UDR 304 generates an enrollment acknowledgement and sends the enrollment acknowledgement to the AUSF/CNF 302. The enrollment acknowledgement 316 includes various data such as the SUPI, A-IDs, AF-IDs, and a success indication, e.g., to indicate the successful storage of data received in the enrollment notification 312. Alternatively, the enrollment acknowledgement 316 includes data such as the SUPI, A-IDs, AF-IDs, and a failure indication, e.g., to indicate that storage of data received in the enrollment notification 312 failed, such as due to a network operator's policy and/or UE API invocation restrictions.

The AUSF/CNF 302 receives the enrollment acknowledgement 316, generates an authentication response 318, and sends the authentication response 318 to the API provider domain 206. Further, the AUSF/CNF 302 stores data received via the enrollment acknowledgement 316 locally. The authentication response 318 includes various data such as the SUPI, K_{CCF}, K_{CAPIF}, and so forth. Alternatively, if the AUSF/CNF 302 determines that authentication failed (e.g., as indicated by the enrollment acknowledgement 316), the authentication response indicates the authentication failure.

In at least one implementation, if K_{CCF} key derivation is not performed at option 310, then the AUSF/CNF 302 in response to receiving the enrollment acknowledgement 316 with success indication, determines to derive and provide K_{CCF} for the API invoker 116. For instance, at option 320, the AUSF/CNF 302 derives K_{CCF} from a most recent K_{AUSF} and/or K_{CAPIF} and a KDF using input parameters such as UE ID, API provider domain 206 ID, CCF ID, A-ID, AF-ID, a CCF security code, and so forth.

As some alternative or additional implementations for option 320:
The AUSF/CNF 302 derives K_{CCF} from the most recent K_{AKMA} available using KDF with one or more input parameters such as UE ID, API provider domain 206 ID, CCF ID, A-IDs, AF-IDs, CCF security code, etc.
If the K_{CCF} is to be derived from K_{CAPIF}, then K_{CAPIF} is to be derived from K_{AUSF} or K_{AKMA}.
K_{CAPIF} can be derived using a KDF using K_{AUSF} and/or K_{AKMA} with input parameters such as UE ID (e.g., SUPI), CAPIF security code, etc.
K_{CCF} can be derived using a KDF using one or more of K_{AUSF}, K_{AKMA}, and/or K_{CAPIF} with input parameters such as UE ID, API provider domain 206 ID, CCF ID, A-IDs, AF-IDs, CCF security code, etc.
The AUSF/CNF 302 can determine to provide the K_{CAPIF} as a root CAPIF key to the API provider domain 206.

The API provider domain receives the authentication response 318 and at 322 stores data from the authentication response 318 and generates an access token. Data stored from the authentication response 318 includes data such as the K_{CCF} and UE context information such as SUPI, CCF ID, CCF Address (e.g., based on local configuration), A-IDs, AF-IDs, and so forth. If the API provider domain 206 receives K_{CAPIF}, then the API provider domain 206 can generate K_{CCF} using KDF with K_{CAPIF} and input parameters such UE ID, API provider domain 206 ID, CCF ID, A-IDs, AF-IDs, CCF security code, etc.

The API provider domain 206 can generate an access token (CCF Access Token) based on K_{CCF} or a key available in the API provider domain 206 (e.g., an Access and Mobility Management Function Key (K_{AMF})) or a key derived from K_{CCF}. The access token (e.g., for onboarding authentication with CCF) can be generated using claims such as UE ID (SUPI/GPSI), API provider domain 206 ID, CCF ID, an ‘Onboarding Enrollment code’, A-IDs, AF-IDs, etc. In such an example implementation the access token can also be stored along with the UE context of SUPI along with the corresponding application identification information.

For the CCF Access Token: Token Claims (K_{CCF}/hash of K_{CCF}, Resource owner: UE ID (SUPI/GPSI), API provider domain 206 ID, Validator: CCF ID, ‘Onboarding Enrolment code’, and Client: A-IDs/AF-IDs). The API provider domain 206 can generate an identifier (K_{CCF} ID) based on K_{CCF}, a key available in the API provider domain 206 (e.g., K_{AMF}), a key derived from K_{CCF}, e.g., K_{API provider domain 206}). The access token (e.g., for onboarding authentication with CCF) can be generated by hashing (e.g., generating a message digest of) a selected key, UE ID, API provider domain 206 ID, A-IDs, AF-IDs, and CCF ID. The K_{CCF} ID can be used to identify the K_{CCF} and related API invocation information for the API invoker 116 and/or UE in the API provider domain 206. For the CCF Key Identifier (K_{CCF} ID) Generation: Hash (K_{CCF}, UE ID (SUPI/GPSI), API provider domain 206 ID, CCF ID, and A-IDs/AF-IDs.

Alternatively, the access token can be used to identify the K_{CCF} for an API invoker and/or UE in the API provider domain 206. As yet another alternative, if the CCF key is to be derived at the API provider domain 206, then the API provider domain 206 can derive K_{CCF} with a KDF using K_{API provider domain 206} and/or K_{AMF} and input parameters such as UE ID, API provider domain 206 ID, AEF ID, CCF ID, A-IDs, AF-IDs, CCF security code, and so forth.

The API provider domain 206 generates an enrollment response 324 and sends the enrollment response 324 to the API invoker 116. The enrollment response 324 can include different data such as a success indication that the API invoker 116 was successfully enrolled for onboarding, UE ID (SUPI/GPSI), K_{CCF} and/or K_{CCF} ID, API provider domain 206 ID, CCF ID, CCF address, A-ID(s), AF-ID(s), and the access token. The API invoker 116 at 326 can then store this data from the enrollment response 324. The API invoker 116 can use the K_{CCF} ID and/or access token to authenticate with the CCF for onboarding (e.g., as described below) and the K_{CCF} can be used to establish a secure connection between the API invoker 116 and CCF, such as based on Transport Layer Security (TLS) pre-shared key (PSK).

According to various implementations where the API invoker 116 receives a UE ID (SUPI/GPSI), K_{CCF} ID, an API provider domain 206 ID, an API provider domain 206 address, CCF ID and/or CCF address, A-ID(s) and/or AF-ID(s) and the access token, and a UE can derive the K_{CCF} and K_{CCF} ID similar to the API provider domain 206 and/or the AUSF/CNF 302 (such as described above), the UE can provide the K_{CCF} and K_{CCF} ID along with other information received via the enrollment response 324 to the API invoker 116, e.g., an application residing in an upper layer of the UE.

Some alternative or additional options for the onboarding enrollment procedure 300 include:
For operations of the AUSF/CNF 302: An AMF and/or other network function can be used instead of AUSF/CNF 302. Thus, the operations and actions described above with reference to the AUSF/CNF 302 can be performed by a different network function. In such examples instead of using K_{AUSF}, a K_{AMF} or a network function key (K_{NF}) can be used to derive K_{CAPIF} or K_{CCF}.
For operations of the UDM/UDR 304: An Unstructured Data Storage Function (UDSF) or other network function can perform the operations and actions described above with reference to the UDM/UDR 304. In such examples the UDSF or other network function stores Subscriber aware API Invocation information such as API details, service ID(s), required API(s) information, exposure information details, user consent information, application client/application server identification exposure restriction data were stored and managed by the network, and so forth.
For the access token, the access token may include addition service authorization information or a list that points to a type of service allowed for the API invoker 116.
If the API provider domain 206 after receiving the enrollment request 306 finds a related UE (e.g., resource owner/user) context (e.g., a key related to a CAPIF) locally available related to the UE ID, then the API provider domain 206 can perform the actions described at 322 and skip the interactions with the AUSF/CNF 302 described above. Further, the API provider domain 206 can derives CCF key from the CAPIF Key (if available) as discussed above. In such an implementation, the API provider domain 206 may interact directly with the UDI/UDR 304, and/or other storage functionality that handles/stores UE and user consent data, e.g., a UDSF.

This section provides some details of the various security keys that are usable as part of implementations for API access management in wireless systems:
K_{AUSF} and/or K_{AKMA} can be used to generate K_{CAPIF}, which can be used to generate K_{CCF}, which can be used to generate K_{AEF}.
K_{AUSF} and/or K_{AKMA}: Available in a network and a UE can generate it.
K_{CAPIF}: Various network functions (such as AUSF or other network function) in the core network can generate it from K_{AUSF} and/or K_{AKMA} (e.g., related to UE Context) to be used for CAPIF security related to techniques for API access management in wireless systems. K_{CAPIF} can be generated by a UE and provided to an API invoker and/or a network can provide it to the API invoker, such as during onboarding enrollment and/or onboarding.
K_{CCF}: A key used between an API invoker and a CCF to authenticate and establish a secure connection. Various network functions (such as AUSF, API provider domain) in the core network can generate it from K_{CAPIF}, K_{AUSF}, and/or K_{AKMA}. This key can be generated by a UE and/or API invoker. A UE, for instance, can provide it to the API invoker and/or the network can provide it to the API invoker. Further, the CCF can anytime provide a new CCF Key to the API invoker where a new K_{CCF} is derived from previous K_{CCF} with additional freshness parameters.
K_{AEF}: A key used between API invoker and AEF to authenticate and establish a secure connection. Various network functions (such as CCF and/or other network functions) in the core network can generate it from K_{CCF}. This key can be generated by the UE and/or API invoker, the UE can provide it to the API invoker, and/or the network can provide it to the API invoker.

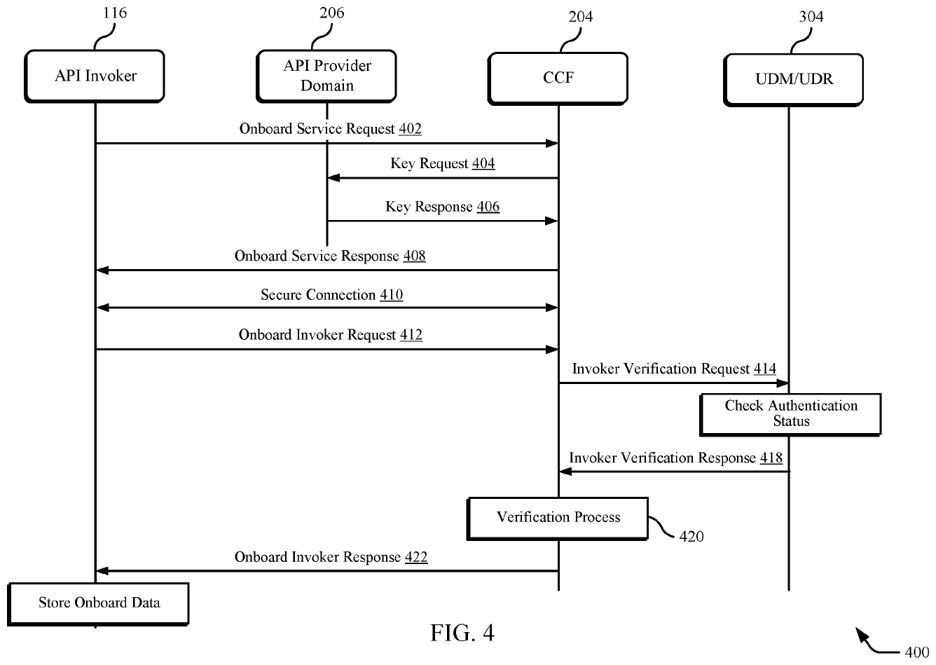

FIG. 4 illustrates an example API invoker onboarding procedure 400 that supports API access management in wireless systems in accordance with aspects of the present disclosure. The onboarding procedure 400 may implement or be implemented by aspects of the wireless communications system 100. In at least one implementation the onboarding procedure 400 is performed after the onboarding enrollment procedure 300. For instance, prior to implementing the onboarding procedure 400, the API invoker receives from the API provider domain onboarding enrolment information such as CCF (Address, Root CA Certificate), an access token, K_{CCF} and/or K_{CCF} ID, APD-F ID and APD-F address, and CCF ID. The onboarding enrollment information, for instance, is used to authenticate and establish a secure TLS communication with the CCF during the onboarding process.

The onboarding procedure 400 describes an example implementation where an API invoker can onboard to the CCF using a K_{CCF} ID and/or access token to authenticate with the CCF for onboarding, and describes how a K_{CCF} related to a K_{CCF} ID and/or access token can be fetched by the CCF to establish secure connection with the CCF to perform the onboarding securely and successfully.

An API invoker and the CAPIF core function (e.g., core network function) may utilize the onboarding procedure 400 to secure and authenticate the onboarding of the API invoker to the CAPIF core function using UE related CCF credential. In at least one implementation the API invoker and the CAPIF core function can establish a secure session using TLS based on the UE related security key, e.g., a CCF credential. As referenced previously, the API invoker can be an application in the UE, an application function, a server related to UE service, the UE itself, and so forth. The API invoker, for instance, performs onboarding procedure 400 for UE service-related API Invocation. In at least one implementation the API invoker can send message exchanges with the CCF using any suitable CAPIF interface.

In this particular implementation the onboarding procedure 400 involves the API invoker 116, the API provider domain 206, the CCF 204, and the UDM/UDR 304. The API invoker sends an onboard service request 402 to the CCF 204. onboard service request 402 can include data such as onboarding type (e.g., ‘User/Subscriber Indication, UE service based’ etc.), K_{CCF} ID, A-ID(s), AF-ID(s), UE ID (e.g., GPSI), API provider domain ID and/or address, and so forth. In at least one implementation, to establish a secure session, the API invoker performs the onboard service request 402 specific for an associated UE (e.g., a user)-based service to enable the CCF 204 to fetch a related CCF security key from the API provider domain 206.

The CCF 204 receives the onboarding service request 402 and uses the API provider domain ID and/or address to contact a network function in the API provider domain 206 to request authentication and CCF security context for the API invoker onboarding. For instance, based on the received onboarding type (e.g., ‘User/Subscriber Indication, UE service based’, etc.), the CCF 204 determines to fetch a security context related to a UE for the associated API invocation. Accordingly, the CCF 204 sends a key request 404 to the API provider domain 206. The key request 404, for instance, includes data such as UE ID (GPSI), K_{CCF} ID, related A-ID(s) and/or AF-ID(s), and so forth.

The API provider domain 206 receives the key request 404 and fetches the SUPI related to the UE ID (e.g., GPSI) and further retrieves the CCF security context (e.g., K_{CCF}, CCF access token) related to the K_{CCF} ID and SUPI for the associated A-ID(s) and/or AF-ID(s). Further the API provider domain 206 provides the SUPI, K_{CCF}, and CCF access token to the CCF in a key response 406. The CCF 204 may send an onboard service response 408 with an authentication request. The API invoker 116 and the CCF 204 can perform authentication (e.g., TLS authentication) and establish secure connection 410 (e.g., secure session) based on using the K_{CCF} (or using a key derived from the K_{CCF} as a pre shared key) shared between API invoker 116 and the CCF 204.

With the secure connection 410 established, the API invoker 116 sends an onboard API invoker Request (“onboard invoker request”) 412 message to the CCF 204. The onboard invoker request 412 message includes an onboard credential obtained during pre-provisioning of the onboard enrollment information (e.g., based on the onboarding enrollment procedure 300), which may include K_{CCF} ID and/or CCF access token. The onboard invoker request 412 message can also include an onboarding type (e.g., ‘User/Subscriber Indication, UE service based’, etc.), UE ID, K_{CCF} ID, A-ID(s) and/or AF-ID(s), a CCF access token, and so forth. In at least one implementation the API invoker 116 may generate an AEF Access Token based on one or more of K_{CCF}, UE ID, API invoker ID, CCF ID, and/or target AEF ID.

In at least some implementations, if the CCF 204 determines that the onboarding procedure 400 is related to potential UE service data exposure, then the CCF 204 performs operations with UDM/UDR 304 to check if the UE has given prior consent information related to allowing the API invoker 116 to consume a service API invocation related to the UE. In such a scenario, the CCF 204 may send an invoker verification request 414 which can include a UE ID (e.g., GPSI/SUPI, A-ID(s)/AF-ID(s), User Consent Check, Service API Information related to A-ID(s)/AF-ID(s), e.g., based on CCF 204 local configuration.

At 416 the UDM/UDR 304 checks the authentication status of the UE related to the UE ID, and if the UE is authenticated in the network, the UDM/UDR 304 further checks the user consent information per A-ID(s)/AF-ID(s) stored along with a service data exposure restriction and/or preference information. If the user consent information available in the UDM/UDR 304 doesn't list A-ID(s)/AF-ID(s) related to the API invoker 116, then the UDM/UDR 304 considers the check as failure. If the user consent information available in the UDM/UDR 304 lists A-ID(s)/AF-ID(s) related to the API invoker 116, then the UDM/UDR 304 considers the check as success.

Accordingly, if the User consent information check at 416 is a success, the UDM/UDR 304 sends an invoker verification response 418 indicating a valid user and/or valid API invoker success indication along with SUPI and user consent information per a service API for the UE/User related to the SUPI. If the User consent information check at 416 is a failure, the UDM/UDR 304 sends the invoker verification response 418 indicating a verification failure. In a failure case, the CCF 204 can skip a verification process 420 and send an onboard invoker response 422 to the API invoker 116 with failure notification.

However, if the invoker verification response 418 indicates that the invoker verification at the UDM/UDR was successful, at 420 the CCF 204 validates an enrollment credential (e.g., CCF access token authorization verification), such as by checking if the CCF access token provided by the API invoker 116 matches the CCF access token received from the API Provider domain 206. If validation of the credential (e.g., the CCF access token) is successful, the CCF 204 can consider the CCF access token as an authorized CCF access token which can be used by the API invoker 116 for further authentication with the CCF 204. The CCF 204 may generate a profile for the API invoker 116, which may include a selected method for AEF authentication and authorization between the API invoker 116 and the AEF 214. Further, the CCF 204 may generate an AEF access token for an assigned API invoker 116 identity. The CCF access token can be used by the API invoker 116 for subsequent authentication procedures with the CCF 204 and the AEF access token can be used for establishing a secure connection and authentication with the AEF 214.

In at least one implementation, if the API invoker 116 corresponds to a UE (e.g., user/subscriber) and/or is related to a UE service, then the CCF 204 derives an Onboard_Secret based on a 5GS key of the UE, such as K_{CCF}. The CCF 204 may generate an Onboard Key and/or Onboard_Secret based on a type of security method to be used for the subscribed Service API for CAPIF-2/2e security as determined by the CCF 204. The Onboard Key and/or Onboard_Secret value can remain the same during the lifetime of the onboarding procedure 400, and can be bound to the CCF 204-specific API invoker ID. The Onboard Secret and AEF Key can be used by the API invoker 116 to authenticate and establish secure session with the AEF 214, such as described below. In at least one implementation the Onboard secret can be derived as follows:
Onboard Key K_{CCF′}=KDF (K_{CCF}, Other input parameters such as API invoker ID, CCF ID, Nonce/random number, etc.)
AEF Key=KDF (Key K_{CCF}/Onboard Key, Other input parameters: API invoker ID, CCF ID, Target AEF ID(s)/information, freshness input such as Nonce/random number, etc.)
Onboard Secret/AEF Access token=Access token generator (Key K_{CCF}, Other input parameters: API invoker ID, CCF ID, Target AEF ID(s)/information, Nonce/random number, etc.)
In at least one implementation, an Onboard Secret can be alternatively termed as AEF access token and vice versa.
In at least one implementation, the Onboard Key can be alternatively called as AEF Key or K_{AEF}.
A new CCF access token=(API invoker ID, CCF ID, CCF Access Token, Nonce/Random number). In at least one implementation the new CCF access token can be used by the API invoker 116 for future access and authentication with the CCF 204 during the same onboarding lifetime.

Based on a successful verification process 420, the CCF 204 can locally store the API invoker profile, API invoker ID, AEF Access Token and/or Onboard Secret, Authorized CCF Access Token, Onboard Key generated for the API invoker along with Target AEF ID(s)/information, and/or New CCF Access Token (if generated based on local policy). Further, the CCF can respond with the onboard invoker response 422 which can include the CAPIF core function assigned API invoker ID, AEF Authentication and authorization information, AEF Access Token and/or Onboard Secret, Authorized CCF Access Token/New CCF Access Token (e.g., if generated based on local policy), AEF Key, Onboard Key generated for the API invoker along with Target AEF ID(s)/information, e.g., if generated by the CCF 204. In an alternative or additional implementation, if the CCF 204 decides that the API invoker 116 is to derive the AEF key, then the CCF 204 provides freshness input parameter used in AEF Key generation to the API invoker as part of the onboard invoker response 422. At 424 the API invoker 116 stores information received from the onboard invoker response 422 and the API invoker 116 is considered onboarded.

In an alternative option for using the UDM/UDR 304: a UDSF or other network function can be involved and perform the actions described above with reference to the UDM/UDR 304 (e.g., instead of the UDM/UDR), where the UDSF or other network function holds Subscriber aware API Invocation information such as API details, service ID, exposure information details, user consent information, application client/application server identification, exposure restriction data, etc.

A CAPID function referred in the onboarding procedure 400 can be any suitable function in the CAPIF framework, e.g., CCF, AEF), and or other function implemented by the CAPIF. Further, in an alternative or additional implementation, an access token may contain addition service authorization information and/or list that points to the type of service allowed for the API invoker.

The following section discusses implementations that enable API invoker CAPIF 1/1e, CAPIF 2/2e authentication and authorization procedures to support implicit UE (i.e., resource owner/user) authentication and authorization where utilized during subscriber aware API invocation (e.g., UE originated API Invocation, UE related API invocation, etc.) by using security keys bound to the UE context for UE originated and/or triggered API invocations.

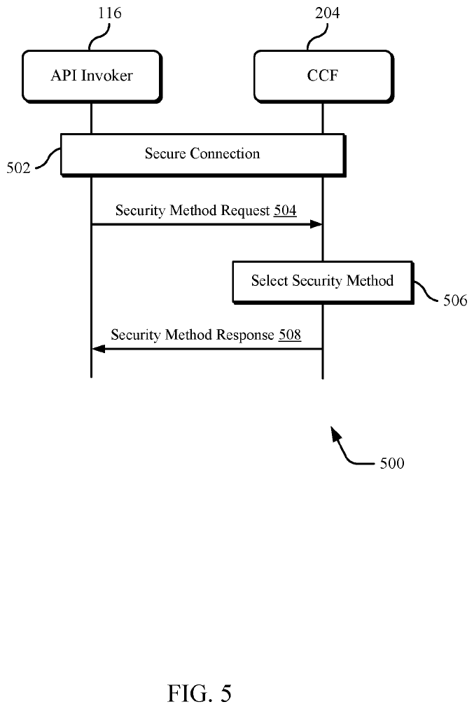

FIG. 5 illustrates an example security method selection procedure 500 that supports API access management in wireless systems in accordance with aspects of the present disclosure. The security method selection procedure 500 may implement or be implemented by aspects of the wireless communications system 100. In at least one implementation the security method selection procedure 500 describes the CAPIF 1/1e authentication and authorization along with the security method selection for CAPIF 2/2e. For instance, a CCF 204 may select TLS PSK as a method of CAPIF 2/2e authentication and authorization if the API invoker 116 resides in a UE or if an API invocation targeted by the API invoker 116 is related to a UE service exposure. The security method selection procedure 500, for instance, describes the use of UE-related security context to perform mutual authentication between an API invoker 116 and a CCF 204 for UE originated and/or triggered API invocation related CAPIF 1/1e authentication and authorization.

At 502 the API invoker 116 and the CCF 204 interact to establish a secure connection between the API invoker 116 and the CCF 204. For instance, the API invoker 116 and the CCF 204 perform mutual authentication for CAPIF 1 or 1e authentication, such based on TLS PSK using an Onboard Key (e.g., a CCF key such as K_{CCF′}) that is shared and/or established between the API invoker 116 and the CCF 204 during a successful CAPIF onboarding procedure, such as described above.

The API invoker 116 sends a security method request 504 to the CCF 204 over the secure connection. In at least one implementation the API invoker 116 may include CAPIF-2/2e security capability information in the security method request 504 message, such as indicating a list of security methods that the API invoker 116 supports over CAPIF-2/2e reference points for each AEF along with the UE ID (or resource owner ID) and the target service API(s) Information list. The UE ID, for instance, can include SUPI, GPSI, 3GPP CAPIF UE ID, and so forth. At 506 the CCF 204 can select a security method (e.g., TLS PSK) to be used over CAPIF-2/2e reference point for each requested AEF, such as based on the information from the API invoker 116 in the security method request 504, UE ID (i.e., if the Resource owner is a UE), access scenarios, and AEF capabilities.

The CCF 204 can send a security method response 508 message to the API invoker 116 indicating the selected security method for each AEF (e.g., TSL-PSK), security information such as AEF Key and AEF Access Token (e.g., if they were not provided to the API invoker during the onboarding procedure) related to the security method. The API invoker 116 can use this method in subsequent communication establishment with AEF, such as over a CAPIF-2/2e reference point. For instance, the AEF Key and AEF Access Token are the security credentials derived from the CCF Key for establishing security between API invoker 116 and the AEF. Further, the AEF Security credential can also be used for authentication and authorization of API invoker 116 with the AEF such as described below. In at least one implementation a CAPIF function referred to in the security method selection procedure 500 can be any function in the CAPIF framework (e.g., CCF, AEF, or other function that belongs to the CAPIF. In an alternative or additional implementation, a UE ID can include a GPSI, UE IP UE ethernet address, UE external group ID, etc.

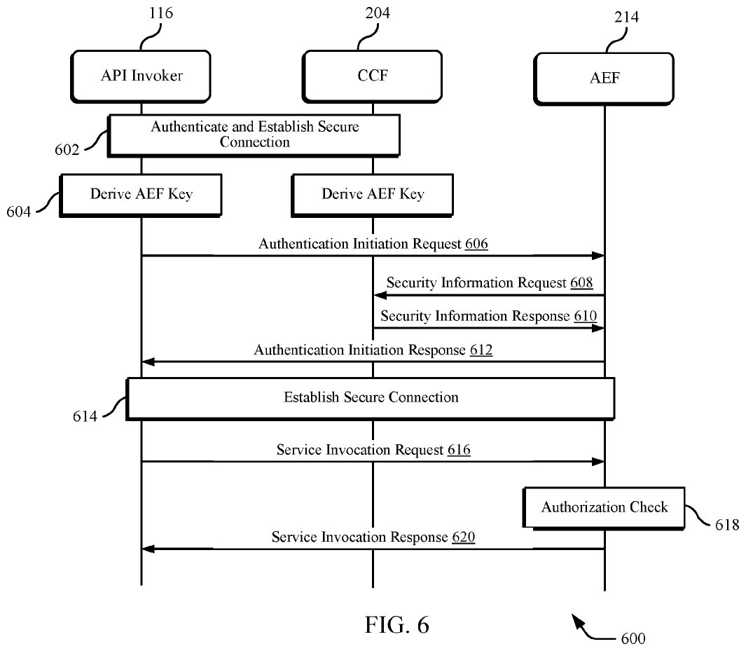

FIG. 6 illustrates an example API invocation procedure 600 that supports API access management in wireless systems in accordance with aspects of the present disclosure. The API invocation procedure 600 may implement or be implemented by aspects of the wireless communications system 100. In at least one implementation the API invocation procedure 600 describes enhancements to CAPIF 2/2e authentication and authorization to enable UE service specific authentication and authorization as described below. The API invocation procedure 600, for instance, describes using UE-related security context to perform mutual authentication between an API invoker and AEF for UE originated/triggered API invocation, such as related to CAPIF 2/2e authentication and authorization.

As part of the API invocation procedure 600, the API invoker 116 and the CCF 204 at 602 authenticate and establish a secure connection. The API invoker 116 and the CCF 204, for instance, perform successful CAPIF 1/1e authentication and authorization, such as based on the security method selection procedure 500. Further, if the API invoker 116 has not received K_{AEF} from the CCF 204 such as during the onboarding procedure, at 604 the API invoker 116 derives K_{AEF} from the K_{CCF}. For instance, the API invoker 116 derives K_{AEF} as follows on a successful CAPIF 1/1e authentication and authorization: K_{AEF}=KDF (K_{CCF}, other input parameters: API invoker ID, UE ID, Application ID/Application function ID, CCF ID, Target AEF ID(s)/information, freshness input such as Nonce/random number received from the CCF 204, etc.)

The API invoker 116 can send an authentication initiation request 606 to the AEF 214, including a CCF assigned API invoker ID and UE ID. In at least one implementation, 602 and 604 of the API invocation procedure 600 may be skipped if the API invoker 116 is already in possession of a valid K_{AEF} following a successful onboarding. In this case, the API invocation procedure 600 can begin with the authentication initiation request 606. The AEF 214 can send a security information request 608 to the CCF 204 requesting security information from the CCF 204 to perform authentication and secure interface establishment with the API invoker 116, e.g., if the AEF 214 does not have a valid key. The security information request 608 can include data such as an API invoker ID and UE ID to request the security information from the CCF 204. The CCF 204 sends a security information response 610 that provides security information related to the selected security method (e.g., TLS-PSK: AEFPSK) along with K_{AEF}, Service API(s) authorization information (e.g., a list of Service APIs which can be invoked by the API invoker 116 related to the UE ID), and an AEF Access token (e.g., to authorize the API invoker 116 to request the service API invocation from the AEF 214). In at least one implementation the security information response 610 is sent to the AEF 214 over a CAPIF-3 reference point. The CCF 204 can also provide a remaining validity timer value for the K_{AEF} (e.g., AEFPSK).

After fetching the relevant AEF Key for the authentication from the CCF 204, the AEF 214 can send an authentication initiation response 612 message to API invoker 116 to initiate secure session establishment 614, e.g., via TLS. In at least one implementation the AEF 214 starts the validity timer based on the value received from the CCF 204 in the security information response 610. For instance, as part of the secure session establishment 614, the API invoker 116 and the AEF 214 can perform mutual authentication using the A K_{AEF} (e.g., the key derived from CCF Key and/or from a key based on a UE Context) and establish a secure session. In at least one implementation, after successful establishment of the secure session (e.g., on a CAPIF-2/2e reference point), the AEF 214 can authorize a service API invocation request by the API invoker 116 based on authorization information (e.g., AEF Access Token) obtained from the CCF 204.

Further to the API invocation procedure 600, the API invoker 116 can send a service invocation request 616 to the AEF 214 which can include requested Service API(s) information, API invoker ID, UE ID, and AEF Access Token (e.g., as received from the CCF 204). The AEF 214 can perform an authorization check 618 by verifying the AEF Access token and Requested Service API(s) information received from the service invocation request 616 with the information (e.g., Service APIs authorization information, AEF Access Token) received from the CCF 204 and stored locally. If the AEF finds as part of the authorization check 618 that the information in the service invocation request 616 matches the information stored at the CCF 204 successfully, the AEF 214 considers the authorization check 618 successful, and can execute an API request from the service invocation request 616 and can send service invocation response 620 indicating a successful API invocation. In at least one implementation the service invocation response 620 can include data obtained from invoking an API requested by the service invocation request 616. If the AEF 214 finds based on the authorization check 618 that the information from the service invocation request 616 does not successfully match the data stored locally on the AEF 214, the AEF 214 considers the AEF 214 considers the authorization check 618 as unsuccessful. Thus, if the authorization check is unsuccessful, the AEF 214 does not execute an API request from the service invocation request 616 and can send the service invocation response 620 indicating a failure of the service invocation request 616.

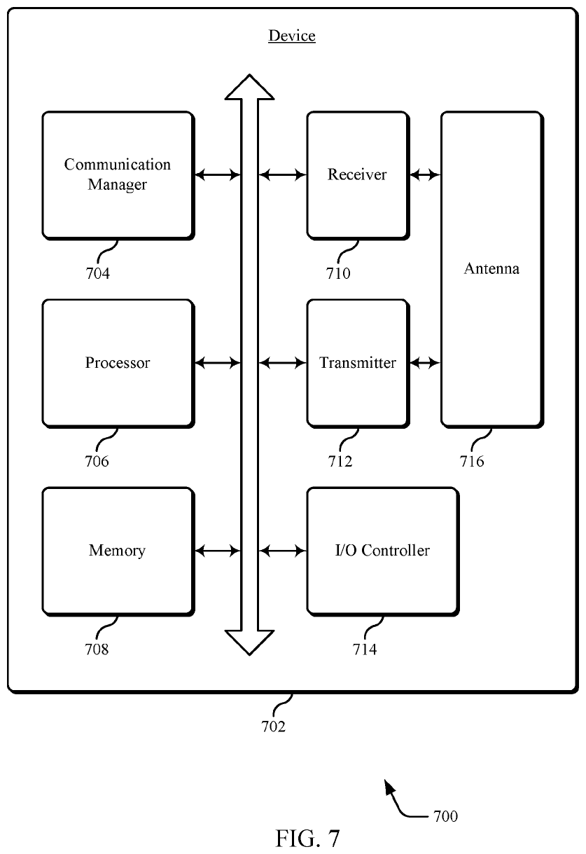

FIG. 7 illustrates an example of a block diagram 700 of a device 702 that supports API access management in wireless systems in accordance with aspects of the present disclosure. The device 702 may be an example of a UE 104 as described herein. The device 702 may support wireless communication and/or network signaling with one or more base stations 102, other UEs 104, or any combination thereof. The device 702 may include components for bi-directional communications including components for transmitting and receiving communications, such as a communications manager 704, a processor 706, a memory 708, a receiver 710, a transmitter 712, and an I/O controller 714. These components may be in electronic communication or otherwise coupled (e.g., operatively, communicatively, functionally, electronically, electrically) via one or more interfaces (e.g., buses).

The communications manager 704, the receiver 710, the transmitter 712, or various combinations thereof or various components thereof may be examples of means for performing various aspects of the present disclosure as described herein. For example, the communications manager 704, the receiver 710, the transmitter 712, or various combinations or components thereof may support a method for performing one or more of the functions described herein.

In some implementations, the communications manager 704, the receiver 710, the transmitter 712, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 706 and the memory 708 coupled with the processor 706 may be configured to perform one or more of the functions described herein (e.g., by executing, by the processor 706, instructions stored in the memory 708).

Additionally or alternatively, in some implementations, the communications manager 704, the receiver 710, the transmitter 712, or various combinations or components thereof may be implemented in code (e.g., as communications management software or firmware) executed by the processor 706. If implemented in code executed by the processor 706, the functions of the communications manager 704, the receiver 710, the transmitter 712, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 704 may be configured to perform various operations (e.g., receiving, monitoring, transmitting) using or otherwise in cooperation with the receiver 710, the transmitter 712, or both. For example, the communications manager 704 may receive information from the receiver 710, send information to the transmitter 712, or be integrated in combination with the receiver 710, the transmitter 712, or both to receive information, transmit information, or perform various other operations as described herein. Although the communications manager 704 is illustrated as a separate component, in some implementations, one or more functions described with reference to the communications manager 704 may be supported by or performed by the processor 706, the memory 708, or any combination thereof. For example, the memory 708 may store code, which may include instructions executable by the processor 706 to cause the device 702 to perform various aspects of the present disclosure as described herein, or the processor 706 and the memory 708 may be otherwise configured to perform or support such operations.

For example, the communications manager 704 may support wireless communication and/or network signaling at a device (e.g., the device 702, a UE) in accordance with examples as disclosed herein. The communications manager 704 and/or other device components may be configured as or otherwise support an apparatus, such as a UE, including a transceiver; and a processor coupled to the transceiver, the processor and the transceiver configured to cause the apparatus to generate an enrollment request requesting enrollment for onboarding with an application programming interface framework core function of a wireless network, the enrollment request including a user equipment identifier for the apparatus; send, to an application programming interface provider domain of the wireless network, the enrollment request; receive an enrollment response that includes enrollment data including key data associated with the application programming interface framework core function of a wireless network; and store the enrollment data for use by the apparatus to perform an onboarding procedure for onboarding one or more of the apparatus or an application related to the apparatus with the application programming interface framework core function of the wireless network to enable the apparatus to invoke one or more application programming interfaces exposed by the application programming interface provider domain.

Additionally, the apparatus (e.g., a UE) includes any one or combination of: wherein the apparatus comprises one or more of a user equipment or a network apparatus that interfaces with the user equipment, and wherein the onboarding procedure is for onboarding an application programming interface invoker of the user equipment, the application programming interface invoker comprising one or more of the application residing on the user equipment or a function residing on the user equipment; wherein to generate the enrollment request further comprises to generate the enrollment request to include one or more of an application identifier for an application that resides on the apparatus, an application function identifier for the application that resides on the apparatus, or user consent information indicating user consent to onboard with the application programming interface framework core function; wherein the user equipment identifier for the apparatus includes one or more of a generic public subscription identifier for the apparatus, a user equipment internet protocols address for the apparatus, an ethernet address for the apparatus, an external group identifier for the apparatus, or an application programming interface framework apparatus identifier for the apparatus; wherein the enrollment data further includes one or more of an indication that the apparatus is successful enrolled for onboarding with the application programming interface framework core function, an authentication key, key data identifier, an application programming function provider domain function identifier, an application programming interface framework core function identifier, an application programming interface framework core function address, an application identifier, an application function identifier, or an access token; wherein the key data comprises one or more of an application programming interface framework core function key, an application programming interface framework core function key identifier, or an application programming interface exposing function key; wherein the processor and the transceiver are further configured to cause the apparatus to: generate an onboard service request to request to onboard to the application programming interface framework core function of the wireless network, the onboard request including the user equipment identifier for the apparatus and a key identifier; send, to the application programming interface framework core function, the onboard service request; establish a secure connection between the apparatus and the application programming interface framework core function using an authentication key derived based on the key data; send, via the secure connection, an onboard application programming interface invoker request to the application programming interface framework core function, the onboard application programming interface invoker request including the key identifier; and receive, via the secure connection and from the application programming interface framework core function, an onboard application programming interface invoker response that identifies an instance of an application programming interface invoker identifier assigned to the apparatus and application programming interface exposing function access information; wherein: the onboard service request further includes one or more of an onboarding type for the onboard service request, an application identifier for an application of the apparatus, an application identifier for the application of the apparatus, an application function identifier for an application of the apparatus, or an application programming interface exposing function identifier; and the onboard application programming interface invoker request further includes one or more of an onboarding type, an application identifier for an application of the apparatus, an application function identifier for an application of the apparatus, or an access token wherein the application programming interface exposing function access information comprises one or more of an application programming interface exposing function access token, an application programming interface exposing function onboard secret, an application programming interface framework core function access token, or an application programming interface exposing function key; wherein the application programming interface exposing function access information comprises an input parameter for use by the apparatus to generate an application programming interface exposing function key for enabling access to the application programming interface exposing function; wherein the application programming interface exposing function access information comprises an input parameter for use by the apparatus to generate an application programming interface exposing function key for enabling access to the application programming interface exposing function.

In another example, the communications manager 704 and/or other device components may be configured as or otherwise support an apparatus, such as a UE, including a transceiver; and a processor coupled to the transceiver, the processor and the transceiver configured to cause the apparatus to generate an onboard service request to request to onboard to an application programming interface framework core function of a wireless network, the onboard request including a user equipment identifier for the apparatus and key data; send, to the application programming interface framework core function, the onboard service request; establish a secure connection between the apparatus and the application programming interface framework core function using an authentication key derived based on the key data; send, via the secure connection, an onboard application programming interface invoker request to the application programming interface framework core function, the onboard application programming interface invoker request including the key data; and receive, via the secure connection and from the application programming interface framework core function, an onboard application programming interface invoker response that identifies an instance of an application programming interface invoker identifier assigned to the apparatus and application programming interface exposing function access information.

Additionally, the apparatus (e.g., a UE) includes any one or combination of: wherein the apparatus comprises a user equipment and wherein the processor and the transceiver are further configured to cause the apparatus to perform one or more of to: execute an application to generate the onboard service request and the onboard application programming interface invoker request; or communicate with a server function to generate the onboard service request and the onboard application programming interface invoker request; wherein the processor and the transceiver are further configured to cause the apparatus to obtain the key data as part of an onboarding enrollment procedure performed with an application programming interface provider domain of the wireless network; wherein the onboard service request further includes one or more of an onboarding type for the onboard service request, an application identifier for an application of the apparatus, an application function identifier for an application of the apparatus, or an application programming interface exposing function identifier; wherein to establish the secure connection between the apparatus and the application programming interface framework core function comprises to establish a secure connection using a key derived based on the key data; wherein the onboard application programming interface invoker request further includes one or more of an onboarding type, user equipment identifier, an application identifier for an application of the apparatus, an application function identifier for an application of the apparatus, or an access token; wherein the application programming interface exposing function access information comprises one or more of an application programming interface exposing function access token, an application programming interface exposing function onboard secret, an application programming interface framework core function access token, or an application programming interface exposing function key; wherein the application programming interface exposing function access information comprises an input parameter for use by the apparatus to generate an application programming interface exposing function key for enabling access to the application programming interface exposing function.

In another example, the communications manager 704 and/or other device components may be configured as or otherwise support an apparatus, such as a UE, including a transceiver; and a processor coupled to the transceiver, the processor and the transceiver configured to cause the apparatus to obtain an application programming interface exposing function key associated with an application programming interface exposing function of a wireless network; send an authentication initiation request to the application programming interface exposing function, the authentication initiation request including an application programming interface invoker identifier and a user equipment identifier for the apparatus; receive an authentication initiation response from the application programming interface exposing function, and establish a secure connection with the application programming interface exposing function using the application programming interface exposing function key; send, over the secure connection, a service invocation request to the application programming interface exposing function, the service invocation request including one or more of: user equipment identifier, an access token, or an application programming interface request identifying an application programming interface to be invoked; and receive, over the secure connection and from the application programming interface exposing function, a service invocation response indicating a result of the application programming interface request.

Additionally, the apparatus (e.g., a UE) includes any one or combination of: wherein the apparatus comprises a user equipment and wherein the processor and the transceiver are further configured to cause the apparatus to perform one or more of to: execute an application to generate the authentication initiation request and the service invocation request; or communicate with a server function to generate the authentication initiation request and the service invocation request; wherein to obtain the application programming interface exposing function key comprises to: obtain an application programming interface framework core function key via interaction with an application programming interface framework core function of the wireless network; and apply a key derivation function to the application programming interface framework core function key to generate the application programming interface exposing function key, the key derivation function utilizing input parameters including one or more of an application programming interface invoker identifier, the user equipment identifier, an application identifier, an application function identifier, an application programming interface framework core function identifier, a target application programming interface exposing function identifier, target application programming interface exposing function information, a nonce received from the application programming interface framework core function, or a random number received from the application programming interface framework core function; wherein the authentication initiation request further includes one or more of an application identifier or an application function identifier for an application that resides on the apparatus; wherein the access token is obtained by implementing the processor and the transceiver to cause the apparatus to: send, to an application programming interface framework core function of the wireless network, an onboard application programming interface invoker request; and receive, from the application programming interface framework core function, an onboard application programming interface invoker response that includes the access token; wherein the processor and the transceiver are further configured to cause the apparatus to: send, to an application programming interface framework core function of the wireless network, a security method request including the user equipment identifier for the apparatus; receive, from the application programming interface framework core function, a security method response that identifies a security method; and establish the secure connection with the application programming interface exposing function using the security method.

The communications manager 704 and/or other device components may be configured as or otherwise support a means for wireless communication and/or network signaling at a UE, including generating an enrollment request requesting enrollment for onboarding with an application programming interface framework core function of a wireless network, the enrollment request including a user equipment identifier for the apparatus; sending, to an application programming interface provider domain of the wireless network, the enrollment request; receive an enrollment response that includes enrollment data including key data associated with the application programming interface framework core function of a wireless network; and storing the enrollment data for use by the apparatus to perform an onboarding procedure for onboarding one or more of the apparatus or an application related to the apparatus with the application programming interface framework core function of the wireless network to enable the apparatus to invoke one or more application programming interfaces exposed by the application programming interface provider domain.

Additionally, wireless communication at the UE includes any one or combination of: wherein the apparatus comprises one or more of a user equipment or a network apparatus that interfaces with the user equipment, and wherein the onboarding procedure is for onboarding an application programming interface invoker of the user equipment, the application programming interface invoker comprising one or more of the application residing on the user equipment or a function residing on the user equipment; wherein generating the enrollment request further comprises generating the enrollment request to include one or more of an application identifier for an application that resides on the apparatus, an application function identifier for the application that resides on the apparatus, or user consent information indicating user consent to onboard with the application programming interface framework core function; wherein the user equipment identifier for the apparatus includes one or more of a generic public subscription identifier for the apparatus, a user equipment internet protocols address for the apparatus, an ethernet address for the apparatus, an external group identifier for the apparatus, or an application programming interface framework apparatus identifier for the apparatus; wherein the enrollment data further includes one or more of an indication that the apparatus is successful enrolled for onboarding with the application programming interface framework core function, an authentication key, key data identifier, an application programming function provider domain function identifier, an application programming interface framework core function identifier, an application programming interface framework core function address, an application identifier, an application function identifier, or an access token; wherein the key data comprises one or more of an application programming interface framework core function key, an application programming interface framework core function key identifier, or an application programming interface exposing function key; generating an onboard service request to request to onboard to the application programming interface framework core function of the wireless network, the onboard request including the user equipment identifier for the apparatus and a key identifier; send, to the application programming interface framework core function, the onboard service request; establishing a secure connection between the apparatus and the application programming interface framework core function using an authentication key derived based on the key data; sending, via the secure connection, an onboard application programming interface invoker request to the application programming interface framework core function, the onboard application programming interface invoker request including the key identifier; and receiving, via the secure connection and from the application programming interface framework core function, an onboard application programming interface invoker response that identifies an instance of an application programming interface invoker identifier assigned to the apparatus and application programming interface exposing function access information; wherein: the onboard service request further includes one or more of an onboarding type for the onboard service request, an application identifier for an application of the apparatus, an application identifier for the application of the apparatus, an application function identifier for an application of the apparatus, or an application programming interface exposing function identifier; and the onboard application programming interface invoker request further includes one or more of an onboarding type, an application identifier for an application of the apparatus, an application function identifier for an application of the apparatus, or an access token wherein the application programming interface exposing function access information comprises one or more of an application programming interface exposing function access token, an application programming interface exposing function onboard secret, an application programming interface framework core function access token, or an application programming interface exposing function key; wherein the application programming interface exposing function access information comprises an input parameter for use by the apparatus to generate an application programming interface exposing function key for enabling access to the application programming interface exposing function; wherein the application programming interface exposing function access information comprises an input parameter for use by the apparatus to generate an application programming interface exposing function key for enabling access to the application programming interface exposing function.

The communications manager 704 and/or other device components may be configured as or otherwise support a means for wireless communication and/or network signaling at a UE, including generating an onboard service request to request to onboard to an application programming interface framework core function of a wireless network, the onboard request including a user equipment identifier for the apparatus and key data; sending, to the application programming interface framework core function, the onboard service request; establishing a secure connection between the apparatus and the application programming interface framework core function using an authentication key derived based on the key data; sending, via the secure connection, an onboard application programming interface invoker request to the application programming interface framework core function, the onboard application programming interface invoker request including the key data; and receiving, via the secure connection and from the application programming interface framework core function, an onboard application programming interface invoker response that identifies an instance of an application programming interface invoker identifier assigned to the apparatus and application programming interface exposing function access information.

Additionally, wireless communication at the UE includes any one or combination of: wherein the apparatus comprises a user equipment, further comprising executing an application to generate the onboard service request and the onboard application programming interface invoker request; or communicating with a server function to generate the onboard service request and the onboard application programming interface invoker request; causing the apparatus to obtain the key data as part of an onboarding enrollment procedure performed with an application programming interface provider domain of the wireless network; wherein the onboard service request further includes one or more of an onboarding type for the onboard service request, an application identifier for an application of the apparatus, an application function identifier for an application of the apparatus, or an application programming interface exposing function identifier; wherein establishing the secure connection between the apparatus and the application programming interface framework core function comprises to establish a secure connection using a key derived based on the key data; wherein the onboard application programming interface invoker request further includes one or more of an onboarding type, user equipment identifier, an application identifier for an application of the apparatus, an application function identifier for an application of the apparatus, or an access token; wherein the application programming interface exposing function access information comprises one or more of an application programming interface exposing function access token, an application programming interface exposing function onboard secret, an application programming interface framework core function access token, or an application programming interface exposing function key; wherein the application programming interface exposing function access information comprises an input parameter for use by the apparatus to generate an application programming interface exposing function key for enabling access to the application programming interface exposing function.

The communications manager 704 and/or other device components may be configured as or otherwise support a means for wireless communication and/or network signaling at a UE, including obtaining an application programming interface exposing function key associated with an application programming interface exposing function of a wireless network; sending an authentication initiation request to the application programming interface exposing function, the authentication initiation request including an application programming interface invoker identifier and a user equipment identifier for the apparatus; receiving an authentication initiation response from the application programming interface exposing function, and establishing a secure connection with the application programming interface exposing function using the application programming interface exposing function key; sending, over the secure connection, a service invocation request to the application programming interface exposing function, the service invocation request including one or more of: user equipment identifier, an access token, or an application programming interface request identifying an application programming interface to be invoked; and receiving, over the secure connection and from the application programming interface exposing function, a service invocation response indicating a result of the application programming interface request.

Additionally, wireless communication at the UE includes any one or combination of: wherein the apparatus comprises a user equipment and: executing an application to generate the authentication initiation request and the service invocation request; or communicating with a server function to generate the authentication initiation request and the service invocation request; wherein to obtain the application programming interface exposing function key comprises obtaining an application programming interface framework core function key via interaction with an application programming interface framework core function of the wireless network; and applying a key derivation function to the application programming interface framework core function key to generate the application programming interface exposing function key, the key derivation function utilizing input parameters including one or more of an application programming interface invoker identifier, the user equipment identifier, an application identifier, an application function identifier, an application programming interface framework core function identifier, a target application programming interface exposing function identifier, target application programming interface exposing function information, a nonce received from the application programming interface framework core function, or a random number received from the application programming interface framework core function; wherein the authentication initiation request further includes one or more of an application identifier or an application function identifier for an application that resides on the apparatus; wherein the access token is obtained by sending, to an application programming interface framework core function of the wireless network, an onboard application programming interface invoker request; and receiving, from the application programming interface framework core function, an onboard application programming interface invoker response that includes the access token; sending, to an application programming interface framework core function of the wireless network, a security method request including the user equipment identifier for the apparatus; receiving, from the application programming interface framework core function, a security method response that identifies a security method; and establishing the secure connection with the application programming interface exposing function using the security method.

The processor 706 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 706 may be configured to operate a memory array using a memory controller. In some other implementations, a memory controller may be integrated into the processor 706. The processor 706 may be configured to execute computer-readable instructions stored in a memory (e.g., the memory 708) to cause the device 702 to perform various functions of the present disclosure.

The memory 708 may include random access memory (RAM) and read-only memory (ROM). The memory 708 may store computer-readable, computer-executable code including instructions that, when executed by the processor 706 cause the device 702 to perform various functions described herein. The code may be stored in a non-transitory computer-readable medium such as system memory or another type of memory. In some implementations, the code may not be directly executable by the processor 706 but may cause a computer (e.g., when compiled and executed) to perform functions described herein. In some implementations, the memory 708 may include, among other things, a basic I/O system (BIOS) which may control basic hardware or software operation such as the interaction with peripheral components or devices.

The I/O controller 714 may manage input and output signals for the device 702. The I/O controller 714 may also manage peripherals not integrated into the device 702. In some implementations, the I/O controller 714 may represent a physical connection or port to an external peripheral. In some implementations, the I/O controller 714 may utilize an operating system such as iOS®, ANDROID®, MS-DOS®, MS-WINDOWS®, OS/2®, UNIX®, LINUX®, or another known operating system. In some implementations, the I/O controller 714 may be implemented as part of a processor, such as the processor 706. In some implementations, a user may interact with the device 702 via the I/O controller 714 or via hardware components controlled by the I/O controller 714.

In some implementations, the device 702 may include a single antenna 716. However, in some other implementations, the device 702 may have more than one antenna 716, which may be capable of concurrently transmitting or receiving multiple wireless transmissions. The receiver 710 and the transmitter 712 may communicate bi-directionally, via the one or more antennas 716, wired, or wireless links as described herein. For example, the receiver 710 and the transmitter 712 may represent a wireless transceiver and may communicate bi-directionally with another wireless transceiver. The transceiver may also include a modem to modulate the packets, to provide the modulated packets to one or more antennas 716 for transmission, and to demodulate packets received from the one or more antennas 716.

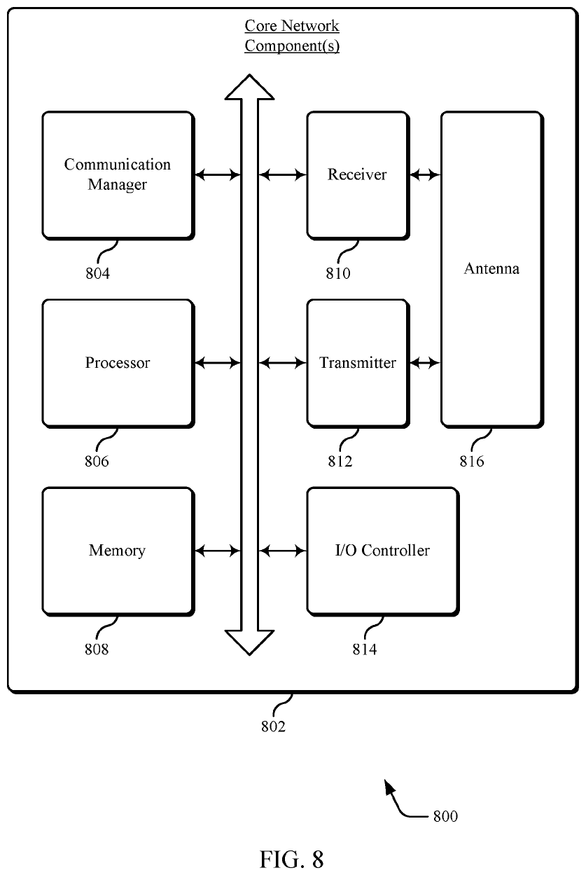

FIG. 8 illustrates an example of a block diagram 800 of a device 802 that supports API access management in wireless systems in accordance with aspects of the present disclosure. The device 802 may be an example of a device implementing a function in a core network, such as core network 106 as described herein. The device 802 may support wireless communication and/or network signaling with one or more base stations 102, other UEs 104, or any combination thereof. The device 802 may include components for bi-directional communications including components for transmitting and receiving communications, such as a communications manager 804, a processor 806, a memory 808, a receiver 810, a transmitter 812, and an I/O controller 814. These components may be in electronic communication or otherwise coupled (e.g., operatively, communicatively, functionally, electronically, electrically) via one or more interfaces (e.g., buses).

The communications manager 804, the receiver 810, the transmitter 812, or various combinations thereof or various components thereof may be examples of means for performing various aspects of the present disclosure as described herein. For example, the communications manager 804, the receiver 810, the transmitter 812, or various combinations or components thereof may support a method for performing one or more of the functions described herein.

In some implementations, the communications manager 804, the receiver 810, the transmitter 812, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 806 and the memory 808 coupled with the processor 806 may be configured to perform one or more of the functions described herein (e.g., by executing, by the processor 806, instructions stored in the memory 808).

Additionally or alternatively, in some implementations, the communications manager 804, the receiver 810, the transmitter 812, or various combinations or components thereof may be implemented in code (e.g., as communications management software or firmware) executed by the processor 806. If implemented in code executed by the processor 806, the functions of the communications manager 804, the receiver 810, the transmitter 812, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 804 may be configured to perform various operations (e.g., receiving, monitoring, transmitting) using or otherwise in cooperation with the receiver 810, the transmitter 812, or both. For example, the communications manager 804 may receive information from the receiver 810, send information to the transmitter 812, or be integrated in combination with the receiver 810, the transmitter 812, or both to receive information, transmit information, or perform various other operations as described herein. Although the communications manager 804 is illustrated as a separate component, in some implementations, one or more functions described with reference to the communications manager 804 may be supported by or performed by the processor 806, the memory 808, or any combination thereof. For example, the memory 808 may store code, which may include instructions executable by the processor 806 to cause the device 802 to perform various aspects of the present disclosure as described herein, or the processor 806 and the memory 808 may be otherwise configured to perform or support such operations.

For example, the communications manager 804 may support wireless communication and/or network signaling at a device (e.g., the device 802, core network component) in accordance with examples as disclosed herein. The communications manager 804 and/or other device components may be configured as or otherwise support an apparatus, such as a core network component, including a transceiver; and a processor coupled to the transceiver, the processor and the transceiver configured to cause the apparatus to: receive, from an application programming interface invoker, an enrollment request requesting enrollment for onboarding with an application programming interface framework core function of a wireless network, the enrollment request including a user equipment identifier for the application programming interface invoker; send, to an authentication function of the wireless network, an authentication/authorization request that includes the user equipment identifier and an application programming interface framework core function identifier for the application programming interface framework core function of the wireless network; receive, from the authentication entity, an authentication/authorization response including key data for the application programming interface framework core function of the wireless network; and send, to the application programming interface invoker, an enrollment response that includes an indication that the application programming interface invoker is successfully enrolled for onboarding with the application programming interface framework core function of the wireless network, a key data identifier, and the key data for the application programming interface framework core function of the wireless network.

Additionally, the apparatus (e.g., a core network component) includes any one or combination of: wherein the enrollment request further includes one or more of an application identifier for an application of the application programming interface invoker, an application function identifier for an application of the application programming interface invoker, or user consent information, and wherein the authentication/authorization request further includes the one or more of the application identifier for an application of the application programming interface invoker, the application function identifier for the application of the application programming interface invoker, or the user consent information; wherein the processor and the transceiver are further configured to cause the apparatus to: generate an access token that enables access to the application programming interface framework core function; and include the access token in the enrollment response; wherein the processor and the transceiver are further configured to cause the apparatus to: generate, using the key data, a key that enables secure interaction with the application programming interface framework core function; and include the key in the enrollment response; wherein the processor and the transceiver are further configured to cause the apparatus to: receive, from the application programming interface framework core function and based on an onboard service request from the application programming interface invoker, a request for the key data; and send, to the application programming interface framework core function, the key data.

For example, the communications manager 804 may support wireless communication and/or network signaling at a device (e.g., the device 802, core network component) in accordance with examples as disclosed herein. The communications manager 804 and/or other device components may be configured as or otherwise support an apparatus, such as a core network component, including a transceiver; and a processor coupled to the transceiver, the processor and the transceiver configured to cause the apparatus to: receive an authentication/authorization request for authenticating/authorizing an application programming interface invoker to onboard with an application programming interface framework core function of a wireless network, the authentication/authorization request including a user equipment identifier for the application programming interface invoker and an application programming interface framework core function identifier for the application programming interface framework core function of the wireless network; derive, based on the application programming interface framework core function identifier, key data for the application programming interface framework core function of the wireless network; generate an authentication/authorization response that indicates that the application programming interface invoker is authorized for onboarding with the application programming interface framework core function of the wireless network and that includes the key data for the application programming interface framework core function of the wireless network; and send, to an application programming interface provider domain of the wireless network, the authentication/authorization response.

Additionally, the apparatus (e.g., a core network component) includes any one or combination of: wherein the processor and the transceiver are further configured to cause the apparatus to determine whether a user equipment associated with the application programming interface invoker is authenticated for onboarding with the application programming interface framework core function, and to generate the authentication/authorization response based on to determine that the user equipment associated with the application programming interface invoker is authenticated for onboarding with the application programming interface framework core function; wherein the processor and the transceiver are configured to cause the apparatus to derive the key data as a key that is usable to securely interact with the application programming interface framework core function; wherein the authentication/authorization request further includes one or more of an application identifier for an application of the application programming interface invoker, an application function identifier for an application of the application programming interface invoker, or user consent information and where the processor and the transceiver are configured to cause the apparatus to: send, to a data management entity of the wireless network, the further data; and receive, from the data management entity, an indication that the further data is successfully stored at the data management entity as associated enrollment information for the application programming interface invoker.

For example, the communications manager 804 may support wireless communication and/or network signaling at a device (e.g., the device 802, core network component) in accordance with examples as disclosed herein. The communications manager 804 and/or other device components may be configured as or otherwise support an apparatus, such as a core network component, including a transceiver; and a processor coupled to the transceiver, the processor and the transceiver configured to cause the apparatus to: receive an application programming interface enrollment data notification with enrollment information including at least one of one or more application identifiers, one or more application functional identifiers, a user equipment identifier for a user equipment, or user consent information; store the enrollment information with a subscription identifier and application programming interface identifiers for the user equipment; and send, to an authentication entity of a wireless network, an enrollment acknowledgment including the subscription identifier and indicating successful storage of the enrollment information.

For example, the communications manager 804 may support wireless communication and/or network signaling at a device (e.g., the device 802, core network component) in accordance with examples as disclosed herein. The communications manager 804 and/or other device components may be configured as or otherwise support an apparatus, such as a core network component, including a receiver to: transceiver; and a processor coupled to the transceiver, the processor and the transceiver configured to cause the apparatus to: receive, from an application programming interface invoker, a first onboard request to onboard with an application programming interface framework core function of a wireless network, the onboard request including key data identifier for the application programming interface framework core function; obtain, based on the key data, an authentication key associated with the application programming interface framework core function; establish a secure connection with the application programming interface invoker using one or more of the authentication key or a different key derived using the authentication key; receive, over the secure connection and from the application programming interface invoker, a second onboard request including an onboard credential for the application programming interface invoker; verify, based on the onboard credential, that the application programming interface invoker is verified to onboard with the application programming interface framework core function; and send, to the application programming interface invoker, an onboard response indicating that the application programming interface invoker is onboarded for access to the application programming interface framework core function and including authorization data usable by the application programming interface to invoke one or more application programming interfaces exposed by the wireless network.

For example, the communications manager 804 may support wireless communication and/or network signaling at a device (e.g., the device 802, core network component) in accordance with examples as disclosed herein. The communications manager 804 and/or other device components may be configured as or otherwise support an apparatus, such as a core network component, including a transceiver; and a processor coupled to the transceiver, the processor and the transceiver configured to cause the apparatus to: send, to an application programming interface invoker, an enrollment message that includes an indication that the application programming interface invoker is successfully enrolled for onboarding with an application programming interface framework core function of a wireless network, the enrollment message further including one or more of: key data and key data identifier for the application programming interface framework core function; receive, from the application programming interface framework core function, a key request that includes one or more of: an identifier for the application programming interface invoker, key data identifier and UE ID; and send, to the application programming interface framework core function, a key response that includes one or more of: a key for the application programming interface framework core function, an access token and a subscription identifier for the application programming interface invoker.

For example, the communications manager 804 may support wireless communication and/or network signaling at a device (e.g., the device 802, core network component) in accordance with examples as disclosed herein. The communications manager 804 and/or other device components may be configured as or otherwise support an apparatus, such as a core network component, including a transceiver; and a processor coupled to the transceiver, the processor and the transceiver configured to cause the apparatus to: receive an application programming interface invoker onboard verification request with onboard information including at least one of one or more application identifiers, one or more application functional identifiers, an application programming interface invoker identifier, or user consent information; determine based on the onboard information whether the application programming interface invoker is authenticated for onboarding to an application programming interface framework core function of a wireless network; store the onboard information based on determining that the application programming interface invoker is authenticated for onboarding to the application programming interface framework core function; and send, to the application programming interface framework core function, an application programming interface invoker onboard verification response indicating that the application programming interface invoker is authenticated for onboarding to the application programming interface framework core function.

For example, the communications manager 804 may support wireless communication and/or network signaling at a device (e.g., the device 802, core network component) in accordance with examples as disclosed herein. The communications manager 804 and/or other device components may be configured as or otherwise support an apparatus, such as a core network component, including a transceiver; and a processor coupled to the transceiver, the processor and the transceiver configured to cause the apparatus to: receive, from an application programming interface invoker, an authentication initiation request, the authentication initiation request including an application programming interface invoker identifier and a user equipment identifier associated with the application programming interface invoker; send, to the application programming interface invoker, an authentication initiation response and establish a secure connection with the application programming interface invoker using an application programming interface exposing function key; receive, over the secure connection and from the application programming interface invoker, a service invocation request, the service invocation request including one or more of: user equipment identifier, an access token, or an application programming interface request identifying an application programming interface to be invoked; cause an application programming interface invocation action based on the application programming interface request; and send, over the secure connection and to the application programming interface invoker, a service invocation response indicating a result of the application programming interface invocation action.

Additionally, the apparatus (e.g., a core network component) includes any one or combination of: wherein the user equipment identifier includes one or more of a subscription permanent identifier, a generic public subscription identifier, or a common application programming interface framework user equipment identifier; wherein the processor and the transceiver, in response to the authentication initiation request, are configured to cause the apparatus to: send, to an application programming interface framework core function of a wireless network, a security information request that includes the user equipment identifier; and receive, from the application programming interface framework core function, a security information response that includes the application programming interface exposing function key; wherein the security information response further includes a remaining validity timer value for the application programming interface exposing function key, and wherein the processor and the transceiver are configured to start the validity timer based on the timer value; wherein the security information response further includes one or more of identification information for one or more application programming interfaces that are permitted to be invoked by the application programming interface invoker, or an instance of the access token; wherein the processor and the transceiver, in response to the service invocation request, are configured to cause the apparatus to verify that the application programming interface invoker is permitted to invoke the application programming interface by comparing information from the service invocation request with the security information response; wherein to cause the application programming interface invocation action includes to determine if the information from the service invocation request matches the security information response, and wherein the service invocation response includes application programming interface data in response to the information from the service invocation request matching the security information response, or a failure indication in response to the information from the service invocation request not matching the security information response; wherein the apparatus is associated with an application programming interface exposing function of a wireless network and wherein the processor and the transceiver are configured to cause the apparatus to establish the secure connection using a security method defined for communication between the application programming interface invoker and the application programming interface exposing function, wherein the security method utilizes the application programming interface exposing function key.

For example, the communications manager 804 may support wireless communication and/or network signaling at a device (e.g., the device 802, core network component) in accordance with examples as disclosed herein. The communications manager 804 and/or other device components may be configured as or otherwise support an apparatus, such as a core network component, including a receiver to: a transceiver; and a processor coupled to the transceiver, the processor and the transceiver configured to cause the apparatus to: generate an application programming interface exposing function key associated with an application programming interface exposing function of a wireless network; receive, from an application programming interface exposing function, a security information request including an application programming interface invoker identifier for an application programming interface invoker, and a user equipment identifier associated with the application programming interface invoker; send, to the application programming interface exposing function, a security response including the application programming interface exposing function key, application programming interface service information associated with the application programming interface invoker, and an application programming interface exposing function access token.

For example, the communications manager 804 may support wireless communication and/or network signaling at a device (e.g., the device 802, core network component) in accordance with examples as disclosed herein. The communications manager 804 and/or other device components may be configured as or otherwise support an apparatus, such as a core network component, including a transceiver; and a processor coupled to the transceiver, the processor and the transceiver configured to cause the apparatus to: establish a secure connection with an application programming interface framework core function of a wireless network; send, to the application programming interface framework core function and over the secure connection, a security method request including a user equipment identifier and application programming interface service information; and receive, from the application programming interface framework core function and over the secure connection, a security method response that identifies a security method to be used for communicating with an application programming interface exposing function of the wireless network.

For example, the communications manager 804 may support wireless communication and/or network signaling at a device (e.g., the device 802, core network component) in accordance with examples as disclosed herein. The communications manager 804 and/or other device components may be configured as or otherwise support an apparatus, such as a core network component, including a receiver to: a transceiver; and a processor coupled to the transceiver, the processor and the transceiver configured to cause the apparatus to: establish a secure connection with an application programming interface invoker associated with a wireless network; receive, from the application programming interface invoker and over the secure connection, a security method request including a user equipment identifier for a user equipment, and application programming interface service information; select, based on the user equipment identifier, a security method to be used for communication between the user equipment and an application programming interface exposing function of the wireless network; and send, to the application programming interface invoker and over the secure connection, a security method response that identifies the security method to be used for communication between the user equipment and an application programming interface exposing function of the wireless network.

The communications manager 804 and/or other device components may be configured as or otherwise support a means for wireless communication and/or network signaling at a core network component, including receiving, from an application programming interface invoker, an enrollment request requesting enrollment for onboarding with an application programming interface framework core function of a wireless network, the enrollment request including a user equipment identifier for the application programming interface invoker; sending, to an authentication function of the wireless network, an authentication/authorization request that includes the user equipment identifier and an application programming interface framework core function identifier for the application programming interface framework core function of the wireless network; receiving, from the authentication entity, an authentication/authorization response including key data for the application programming interface framework core function of the wireless network; and sending, to the application programming interface invoker, an enrollment response that includes an indication that the application programming interface invoker is successfully enrolled for onboarding with the application programming interface framework core function of the wireless network, a key data identifier, and the key data for the application programming interface framework core function of the wireless network.

Additionally, wireless communication at the core network component includes any one or combination of: wherein the enrollment request further includes one or more of an application identifier for an application of the application programming interface invoker, an application function identifier for an application of the application programming interface invoker, or user consent information, and wherein the authentication/authorization request further includes the one or more of the application identifier for an application of the application programming interface invoker, the application function identifier for the application of the application programming interface invoker, or the user consent information; generating an access token that enables access to the application programming interface framework core function; and including the access token in the enrollment response; generating, using the key data, a key that enables secure interaction with the application programming interface framework core function; and including the key in the enrollment response; receiving, from the application programming interface framework core function and based on an onboard service request from the application programming interface invoker, a request for the key data; and sending, to the application programming interface framework core function, the key data.

The communications manager 804 and/or other device components may be configured as or otherwise support a means for wireless communication and/or network signaling at a core network component, including receiving an authentication/authorization request for authenticating/authorizing an application programming interface invoker to onboard with an application programming interface framework core function of a wireless network, the authentication/authorization request including a user equipment identifier for the application programming interface invoker and an application programming interface framework core function identifier for the application programming interface framework core function of the wireless network; deriving, based on the application programming interface framework core function identifier, key data for the application programming interface framework core function of the wireless network; generating an authentication/authorization response that indicates that the application programming interface invoker is authorized for onboarding with the application programming interface framework core function of the wireless network and that includes the key data for the application programming interface framework core function of the wireless network; and sending, to an application programming interface provider domain of the wireless network, the authentication/authorization response.

Additionally, wireless communication at the core network component includes any one or combination of: determining whether a user equipment associated with the application programming interface invoker is authenticated for onboarding with the application programming interface framework core function, and generating the authentication/authorization response based on to determine that the user equipment associated with the application programming interface invoker is authenticated for onboarding with the application programming interface framework core function; deriving the key data as a key that is usable to securely interact with the application programming interface framework core function; wherein the authentication/authorization request further includes one or more of an application identifier for an application of the application programming interface invoker, an application function identifier for an application of the application programming interface invoker, or user consent information and further including: sending, to a data management entity of the wireless network, the further data; and receiving, from the data management entity, an indication that the further data is successfully stored at the data management entity as associated enrollment information for the application programming interface invoker.

The communications manager 804 and/or other device components may be configured as or otherwise support a means for wireless communication and/or network signaling at a core network component, including receiving an application programming interface enrollment data notification with enrollment information including at least one of one or more application identifiers, one or more application functional identifiers, a user equipment identifier for a user equipment, or user consent information; storing the enrollment information with a subscription identifier and application programming interface identifiers for the user equipment; and sending, to an authentication entity of a wireless network, an enrollment acknowledgment including the subscription identifier and indicating successful storage of the enrollment information.

The communications manager 804 and/or other device components may be configured as or otherwise support a means for wireless communication and/or network signaling at a core network component, including receiving, from an application programming interface invoker, a first onboard request to onboard with an application programming interface framework core function of a wireless network, the onboard request including key data identifier for the application programming interface framework core function; obtaining, based on the key data, an authentication key associated with the application programming interface framework core function; establish a secure connection with the application programming interface invoker using one or more of the authentication key or a different key derived using the authentication key; receiving, over the secure connection and from the application programming interface invoker, a second onboard request including an onboard credential for the application programming interface invoker; verifying, based on the onboard credential, that the application programming interface invoker is verified to onboard with the application programming interface framework core function; and sending, to the application programming interface invoker, an onboard response indicating that the application programming interface invoker is onboarded for access to the application programming interface framework core function and including authorization data usable by the application programming interface to invoke one or more application programming interfaces exposed by the wireless network.

The communications manager 804 and/or other device components may be configured as or otherwise support a means for wireless communication and/or network signaling at a core network component, including: sending, to an application programming interface invoker, an enrollment message that includes an indication that the application programming interface invoker is successfully enrolled for onboarding with an application programming interface framework core function of a wireless network, the enrollment message further including one or more of: key data and key data identifier for the application programming interface framework core function; receiving, from the application programming interface framework core function, a key request that includes one or more of: an identifier for the application programming interface invoker, key data identifier and UE ID; and sending, to the application programming interface framework core function, a key response that includes one or more of: a key for the application programming interface framework core function, an access token and a subscription identifier for the application programming interface invoker.

The communications manager 804 and/or other device components may be configured as or otherwise support a means for wireless communication and/or network signaling at a core network component, including: receiving an application programming interface invoker onboard verification request with onboard information including at least one of one or more application identifiers, one or more application functional identifiers, an application programming interface invoker identifier, or user consent information; determining based on the onboard information whether the application programming interface invoker is authenticated for onboarding to an application programming interface framework core function of a wireless network; storing the onboard information based on determining that the application programming interface invoker is authenticated for onboarding to the application programming interface framework core function; and sending, to the application programming interface framework core function, an application programming interface invoker onboard verification response indicating that the application programming interface invoker is authenticated for onboarding to the application programming interface framework core function.

The communications manager 804 and/or other device components may be configured as or otherwise support a means for wireless communication and/or network signaling at a core network component, including: receiving, from an application programming interface invoker, an authentication initiation request, the authentication initiation request including an application programming interface invoker identifier and a user equipment identifier associated with the application programming interface invoker; sending, to the application programming interface invoker, an authentication initiation response and establish a secure connection with the application programming interface invoker using an application programming interface exposing function key; receiving, over the secure connection and from the application programming interface invoker, a service invocation request, the service invocation request including one or more of: user equipment identifier, an access token, or an application programming interface request identifying an application programming interface to be invoked; causing an application programming interface invocation action based on the application programming interface request; and sending, over the secure connection and to the application programming interface invoker, a service invocation response indicating a result of the application programming interface invocation action.

Additionally, wireless communication at the core network component includes any one or combination of: wherein the user equipment identifier includes one or more of a subscription permanent identifier, a generic public subscription identifier, or a common application programming interface framework user equipment identifier; wherein in response to the authentication initiation request, sending, to an application programming interface framework core function of a wireless network, a security information request that includes the user equipment identifier; and receiving, from the application programming interface framework core function, a security information response that includes the application programming interface exposing function key; wherein the security information response further includes a remaining validity timer value for the application programming interface exposing function key, and starting the validity timer based on the timer value; wherein the security information response further includes one or more of identification information for one or more application programming interfaces that are permitted to be invoked by the application programming interface invoker, or an instance of the access token; wherein in response to the service invocation request, verifying that the application programming interface invoker is permitted to invoke the application programming interface by comparing information from the service invocation request with the security information response; wherein causing the application programming interface invocation action includes to determine if the information from the service invocation request matches the security information response, and wherein the service invocation response includes application programming interface data in response to the information from the service invocation request matching the security information response, or a failure indication in response to the information from the service invocation request not matching the security information response; wherein the apparatus is associated with an application programming interface exposing function of a wireless network and further including causing the apparatus to establish the secure connection using a security method defined for communication between the application programming interface invoker and the application programming interface exposing function, wherein the security method utilizes the application programming interface exposing function key.

The communications manager 804 and/or other device components may be configured as or otherwise support a means for wireless communication and/or network signaling at a core network component, including: generating an application programming interface exposing function key associated with an application programming interface exposing function of a wireless network; receiving, from an application programming interface exposing function, a security information request including an application programming interface invoker identifier for an application programming interface invoker, and a user equipment identifier associated with the application programming interface invoker; sending, to the application programming interface exposing function, a security response including the application programming interface exposing function key, application programming interface service information associated with the application programming interface invoker, and an application programming interface exposing function access token.

The communications manager 804 and/or other device components may be configured as or otherwise support a means for wireless communication and/or network signaling at a core network component, including: establishing a secure connection with an application programming interface framework core function of a wireless network; sending, to the application programming interface framework core function and over the secure connection, a security method request including a user equipment identifier and application programming interface service information; and receiving, from the application programming interface framework core function and over the secure connection, a security method response that identifies a security method to be used for communicating with an application programming interface exposing function of the wireless network.

The communications manager 804 and/or other device components may be configured as or otherwise support a means for wireless communication and/or network signaling at a core network component, including: establishing a secure connection with an application programming interface invoker associated with a wireless network; receiving, from the application programming interface invoker and over the secure connection, a security method request including a user equipment identifier for a user equipment, and application programming interface service information; selecting, based on the user equipment identifier, a security method to be used for communication between the user equipment and an application programming interface exposing function of the wireless network; and sending, to the application programming interface invoker and over the secure connection, a security method response that identifies the security method to be used for communication between the user equipment and an application programming interface exposing function of the wireless network.

The processor 806 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 806 may be configured to operate a memory array using a memory controller. In some other implementations, a memory controller may be integrated into the processor 806. The processor 806 may be configured to execute computer-readable instructions stored in a memory (e.g., the memory 808) to cause the device 802 to perform various functions of the present disclosure.

The memory 808 may include random access memory (RAM) and read-only memory (ROM). The memory 808 may store computer-readable, computer-executable code including instructions that, when executed by the processor 806 cause the device 802 to perform various functions described herein. The code may be stored in a non-transitory computer-readable medium such as system memory or another type of memory. In some implementations, the code may not be directly executable by the processor 806 but may cause a computer (e.g., when compiled and executed) to perform functions described herein. In some implementations, the memory 808 may include, among other things, a basic I/O system (BIOS) which may control basic hardware or software operation such as the interaction with peripheral components or devices.

The I/O controller 814 may manage input and output signals for the device 802. The I/O controller 814 may also manage peripherals not integrated into the device 802. In some implementations, the I/O controller 814 may represent a physical connection or port to an external peripheral. In some implementations, the I/O controller 814 may utilize an operating system such as iOS®, ANDROID®, MS-DOS®, MS-WINDOWS®, OS/2®, UNIX®, LINUX®, or another known operating system. In some implementations, the I/O controller 814 may be implemented as part of a processor, such as the processor 806. In some implementations, a user may interact with the device 802 via the I/O controller 814 or via hardware components controlled by the I/O controller 814.

In some implementations, the device 802 may include a single antenna 816. However, in some other implementations, the device 802 may have more than one antenna 816, which may be capable of concurrently transmitting or receiving multiple wireless transmissions. The receiver 810 and the transmitter 812 may communicate bi-directionally, via the one or more antennas 816, wired, or wireless links as described herein. For example, the receiver 810 and the transmitter 812 may represent a wireless transceiver and may communicate bi-directionally with another wireless transceiver. The transceiver may also include a modem to modulate the packets, to provide the modulated packets to one or more antennas 816 for transmission, and to demodulate packets received from the one or more antennas 816.

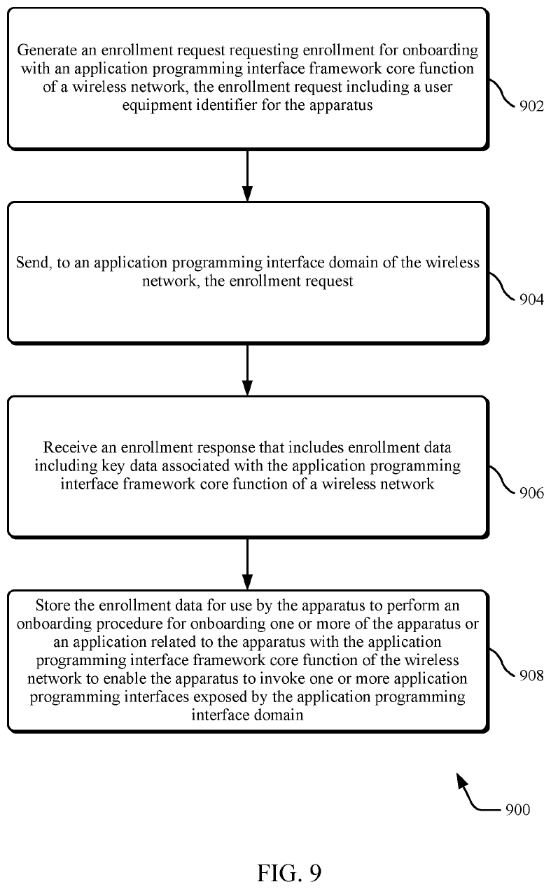

FIG. 9 illustrates a flowchart of a method 900 that supports API access management in wireless systems in accordance with aspects of the present disclosure. The operations of the method 900 may be implemented by a device or its components as described herein. For example, the operations of the method 900 may be performed by a device, such as UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 902, the method may include generating an enrollment request requesting enrollment for onboarding with an application programming interface framework core function of a wireless network, the enrollment request including a user equipment identifier for the apparatus. The operations of 902 may be performed in accordance with examples as described herein. In some implementations, aspects of the operations of 902 may be performed by a device as described with reference to FIG. 1.

At 904, the method may include sending, to an application programming interface provider domain of the wireless network, the enrollment request. The operations of 904 may be performed in accordance with examples as described herein. In some implementations, aspects of the operations of 904 may be performed by a device as described with reference to FIG. 1.

At 906, the method may include receiving an enrollment response that includes enrollment data including key data associated with the application programming interface framework core function of a wireless network. The operations of 906 may be performed in accordance with examples as described herein. In some implementations, aspects of the operations of 906 may be performed by a device as described with reference to FIG. 1.

At 908, the method may include storing the enrollment data for use by the apparatus to perform an onboarding procedure for onboarding one or more of the apparatus or an application related to the apparatus with the application programming interface framework core function of the wireless network to enable the apparatus to invoke one or more application programming interfaces exposed by the application programming interface provider domain. The operations of 908 may be performed in accordance with examples as described herein. In some implementations, aspects of the operations of 908 may be performed by a device as described with reference to FIG. 1.

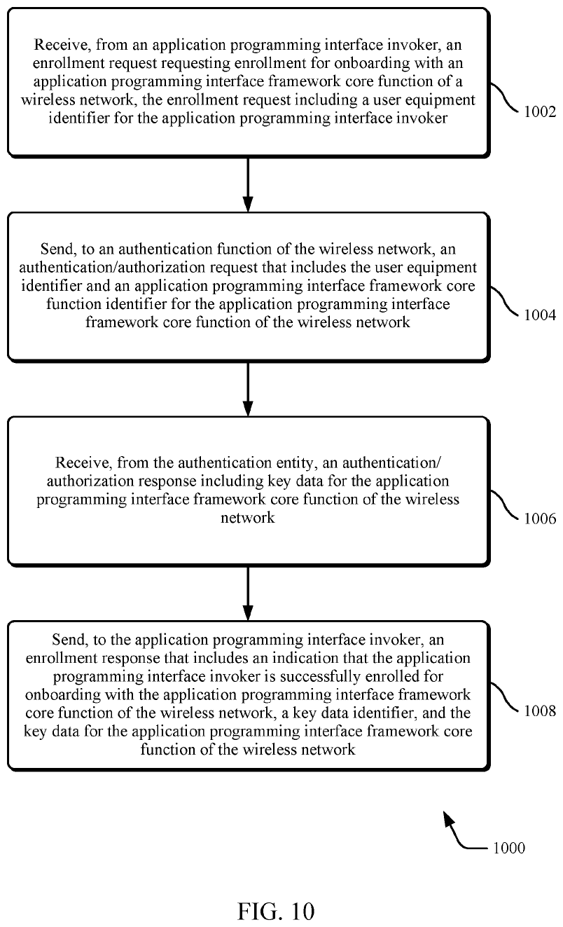

FIG. 10 illustrates a flowchart of a method 1000 that supports API access management in wireless systems in accordance with aspects of the present disclosure. The operations of the method 1000 may be implemented by a device or its components as described herein. For example, the operations of the method 1000 may be performed by a device, such as a component of the core network 106 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1002, the method may include receiving, from an application programming interface invoker, an enrollment request requesting enrollment for onboarding with an application programming interface framework core function of a wireless network, the enrollment request including a user equipment identifier for the application programming interface invoker. The operations of 1002 may be performed in accordance with examples as described herein. In some implementations, aspects of the operations of 1002 may be performed by a device as described with reference to FIG. 1.

At 1004, the method may include sending, to an authentication function of the wireless network, an authentication/authorization request that includes the user equipment identifier and an application programming interface framework core function identifier for the application programming interface framework core function of the wireless network. The operations of 1004 may be performed in accordance with examples as described herein. In some implementations, aspects of the operations of 1004 may be performed by a device as described with reference to FIG. 1.

At 1006, the method may include receiving, from the authentication entity, an authentication/authorization response including key data for the application programming interface framework core function of the wireless network. The operations of 1006 may be performed in accordance with examples as described herein. In some implementations, aspects of the operations of 1006 may be performed by a device as described with reference to FIG. 1.

At 1008, the method may include sending, to the application programming interface invoker, an enrollment response that includes an indication that the application programming interface invoker is successfully enrolled for onboarding with the application programming interface framework core function of the wireless network, a key data identifier, and the key data for the application programming interface framework core function of the wireless network. The operations of 1008 may be performed in accordance with examples as described herein. In some implementations, aspects of the operations of 1008 may be performed by a device as described with reference to FIG. 1.

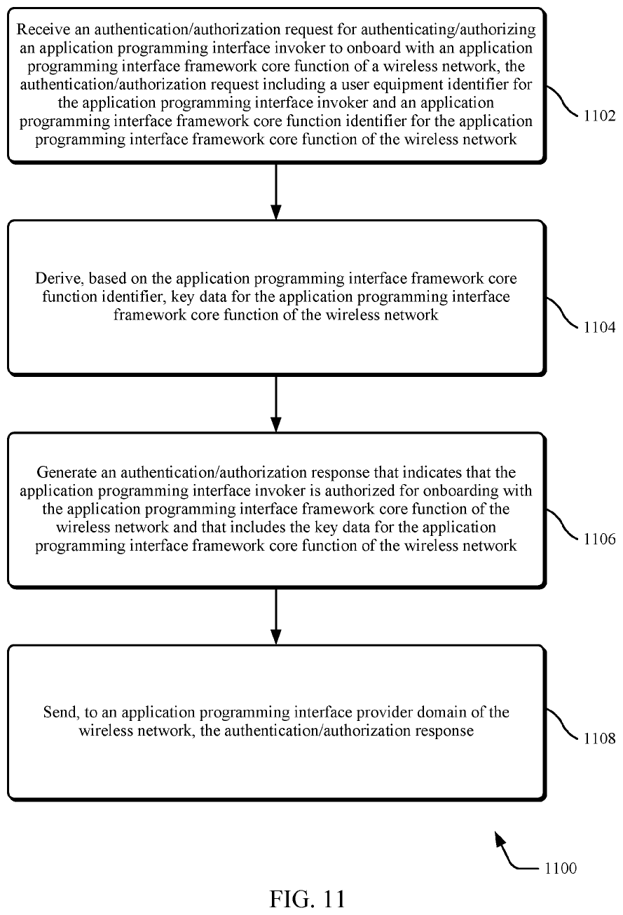

FIG. 11 illustrates a flowchart of a method 1100 that supports API access management in wireless systems in accordance with aspects of the present disclosure. The operations of the method 1100 may be implemented by a device or its components as described herein. For example, the operations of the method 1100 may be performed by a device, such as component of the core network 106 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1102, the method may include receiving an authentication/authorization request for authenticating/authorizing an application programming interface invoker to onboard with an application programming interface framework core function of a wireless network, the authentication/authorization request including a user equipment identifier for the application programming interface invoker and an application programming interface framework core function identifier for the application programming interface framework core function of the wireless network. The operations of 1102 may be performed in accordance with examples as described herein. In some implementations, aspects of the operations of 1102 may be performed by a device as described with reference to FIG. 1.

At 1104, the method may include deriving, based on the application programming interface framework core function identifier, key data for the application programming interface framework core function of the wireless network. The operations of 1104 may be performed in accordance with examples as described herein. In some implementations, aspects of the operations of 1104 may be performed by a device as described with reference to FIG. 1.

At 1106, the method may include generating an authentication/authorization response that indicates that the application programming interface invoker is authorized for onboarding with the application programming interface framework core function of the wireless network and that includes the key data for the application programming interface framework core function of the wireless network. The operations of 1106 may be performed in accordance with examples as described herein. In some implementations, aspects of the operations of 1106 may be performed by a device as described with reference to FIG. 1.

At 1108, the method may include sending, to an application programming interface provider domain of the wireless network, the authentication/authorization response. The operations of 1108 may be performed in accordance with examples as described herein. In some implementations, aspects of the operations of 1108 may be performed by a device as described with reference to FIG. 1.

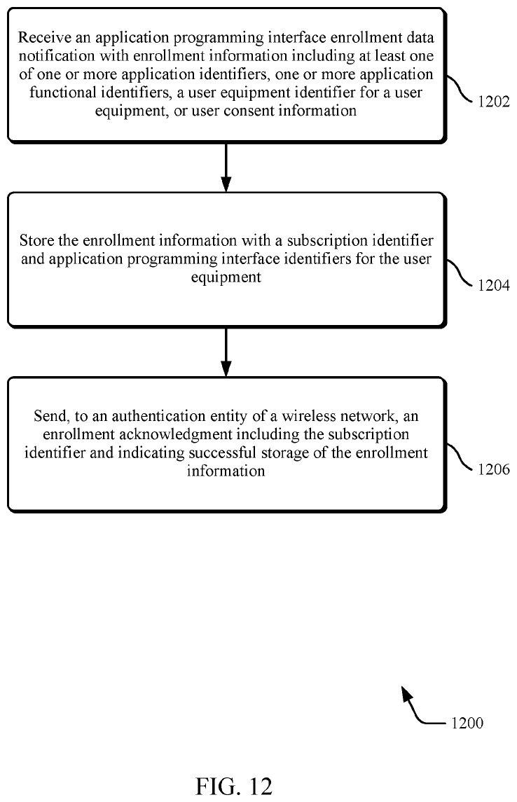

FIG. 12 illustrates a flowchart of a method 1200 that supports API access management in wireless systems in accordance with aspects of the present disclosure. The operations of the method 1200 may be implemented by a device or its components as described herein. For example, the operations of the method 1200 may be performed by a device, such as component of the core network 106 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1202, the method may include receiving an application programming interface enrollment data notification with enrollment information including at least one of one or more application identifiers, one or more application functional identifiers, a user equipment identifier for a user equipment, or user consent information. The operations of 1202 may be performed in accordance with examples as described herein. In some implementations, aspects of the operations of 1202 may be performed by a device as described with reference to FIGS. 1 and 2.

At 1204, the method may include storing the enrollment information with a subscription identifier and application programming interface identifiers for the user equipment. The operations of 1204 may be performed in accordance with examples as described herein. In some implementations, aspects of the operations of 1204 may be performed by a device as described with reference to FIG. 1.

At 1206, the method may include send, to an authentication entity of a wireless network, an enrollment acknowledgment including the subscription identifier and indicating successful storage of the enrollment information. The operations of 1206 may be performed in accordance with examples as described herein. In some implementations, aspects of the operations of 1206 may be performed by a device as described with reference to FIG. 1.

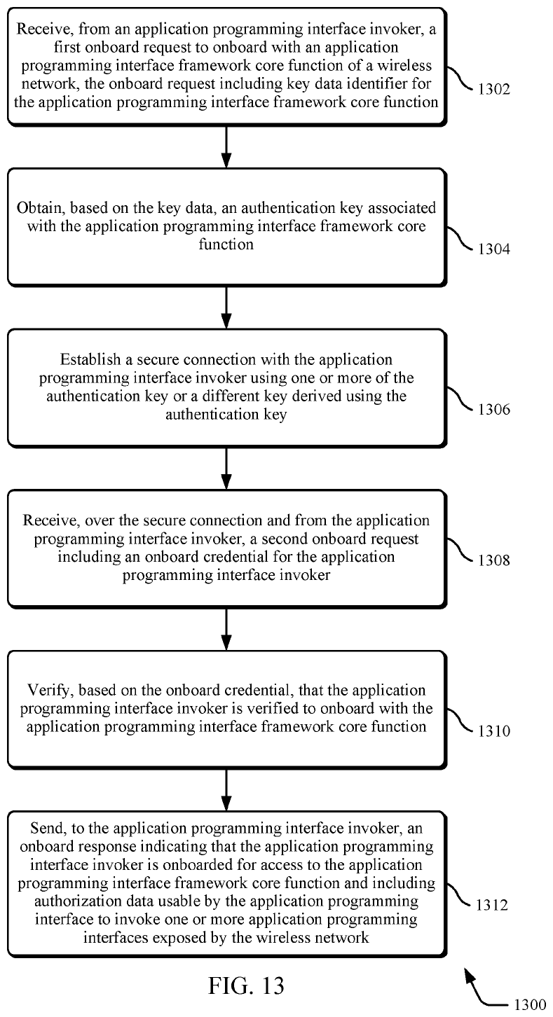

FIG. 13 illustrates a flowchart of a method 1300 that supports API access management in wireless systems in accordance with aspects of the present disclosure. The operations of the method 1300 may be implemented by a device or its components as described herein. For example, the operations of the method 1300 may be performed by a device, such as component of the core network 106 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1302, the method may include receiving, from an application programming interface invoker, a first onboard request to onboard with an application programming interface framework core function of a wireless network, the onboard request including key data identifier for the application programming interface framework core function. The operations of 1302 may be performed in accordance with examples as described herein. In some implementations, aspects of the operations of 1302 may be performed by a device as described with reference to FIGS. 1 and 2.

At 1304, the method may include obtaining, based on the key data, an authentication key associated with the application programming interface framework core function. The operations of 1304 may be performed in accordance with examples as described herein. In some implementations, aspects of the operations of 1304 may be performed by a device as described with reference to FIG. 1.

At 1306, the method may include establishing a secure connection with the application programming interface invoker using one or more of the authentication key or a different key derived using the authentication key. The operations of 1306 may be performed in accordance with examples as described herein. In some implementations, aspects of the operations of 1306 may be performed by a device as described with reference to FIG. 1.

At 1308, the method may include receiving, over the secure connection and from the application programming interface invoker, a second onboard request including an onboard credential for the application programming interface invoker. The operations of 1308 may be performed in accordance with examples as described herein. In some implementations, aspects of the operations of 1308 may be performed by a device as described with reference to FIG. 1.

At 1310, the method may include verifying, based on the onboard credential, that the application programming interface invoker is verified to onboard with the application programming interface framework core function. The operations of 1310 may be performed in accordance with examples as described herein. In some implementations, aspects of the operations of 1310 may be performed by a device as described with reference to FIG. 1.

At 1312, the method may include send, to the application programming interface invoker, an onboard response indicating that the application programming interface invoker is onboarded for access to the application programming interface framework core function and including authorization data usable by the application programming interface to invoke one or more application programming interfaces exposed by the wireless network. The operations of 1312 may be performed in accordance with examples as described herein. In some implementations, aspects of the operations of 1312 may be performed by a device as described with reference to FIG. 1.

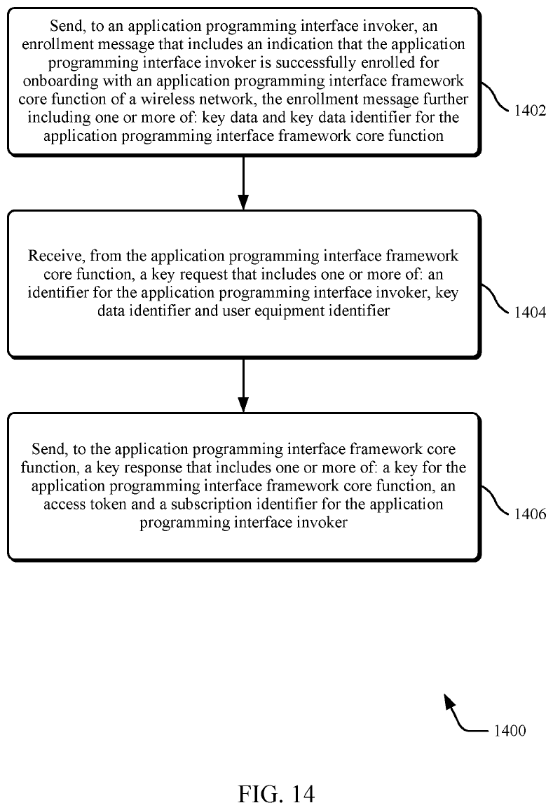

FIG. 14 illustrates a flowchart of a method 1400 that supports API access management in wireless systems in accordance with aspects of the present disclosure. The operations of the method 1400 may be implemented by a device or its components as described herein. For example, the operations of the method 1400 may be performed by a device, such as component of the core network 106 such as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1402, the method may include sending, to an application programming interface invoker, an enrollment message that includes an indication that the application programming interface invoker is successfully enrolled for onboarding with an application programming interface framework core function of a wireless network, the enrollment message further including one or more of: key data and key data identifier for the application programming interface framework core function. The operations of 1402 may be performed in accordance with examples as described herein. In some implementations, aspects of the operations of 1402 may be performed by a device as described with reference to FIGS. 1 and 2.

At 1404, the method may include receiving, from the application programming interface framework core function, a key request that includes one or more of: an identifier for the application programming interface invoker, key data identifier and user equipment identifier. The operations of 1404 may be performed in accordance with examples as described herein. In some implementations, aspects of the operations of 1404 may be performed by a device as described with reference to FIG. 1.

At 1406, the method may include sending, to the application programming interface framework core function, a key response that includes one or more of: a key for the application programming interface framework core function, an access token and a subscription identifier for the application programming interface invoker. The operations of 1406 may be performed in accordance with examples as described herein. In some implementations, aspects of the operations of 1406 may be performed by a device as described with reference to FIG. 1.

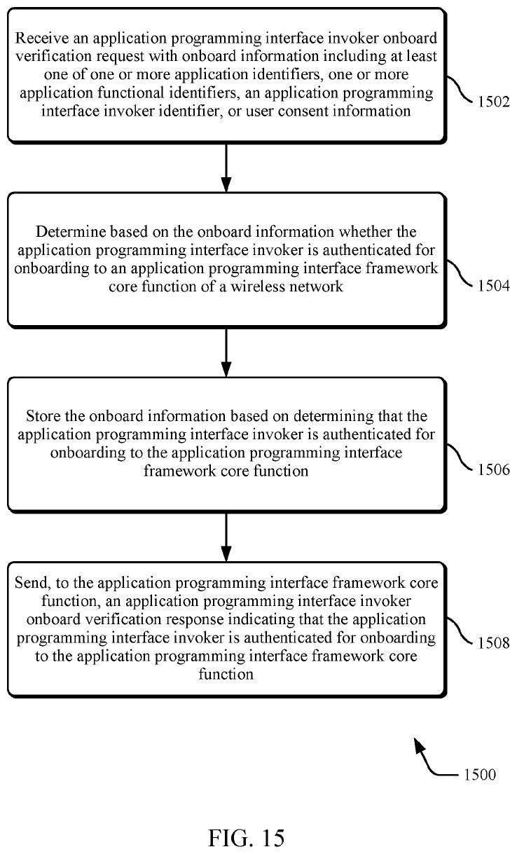

FIG. 15 illustrates a flowchart of a method 1500 that supports API access management in wireless systems in accordance with aspects of the present disclosure. The operations of the method 1500 may be implemented by a device or its components as described herein. For example, the operations of the method 1500 may be performed by a device, such as a component of the core network 106 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1502, the method may include receiving an application programming interface invoker onboard verification request with onboard information including at least one of one or more application identifiers, one or more application functional identifiers, an application programming interface invoker identifier, or user consent information. The operations of 1502 may be performed in accordance with examples as described herein. In some implementations, aspects of the operations of 1502 may be performed by a device as described with reference to FIGS. 1 and 2.

At 1504, the method may include determining based on the onboard information whether the application programming interface invoker is authenticated for onboarding to an application programming interface framework core function of a wireless network. The operations of 1504 may be performed in accordance with examples as described herein. In some implementations, aspects of the operations of 1504 may be performed by a device as described with reference to FIG. 1.

At 1506, the method may include storing the onboard information based on determining that the application programming interface invoker is authenticated for onboarding to the application programming interface framework core function. The operations of 1506 may be performed in accordance with examples as described herein. In some implementations, aspects of the operations of 1506 may be performed by a device as described with reference to FIG. 1.

At 1508, the method may include sending, to the application programming interface framework core function, an application programming interface invoker onboard verification response indicating that the application programming interface invoker is authenticated for onboarding to the application programming interface framework core function. The operations of 1508 may be performed in accordance with examples as described herein. In some implementations, aspects of the operations of 1508 may be performed by a device as described with reference to FIG. 1.

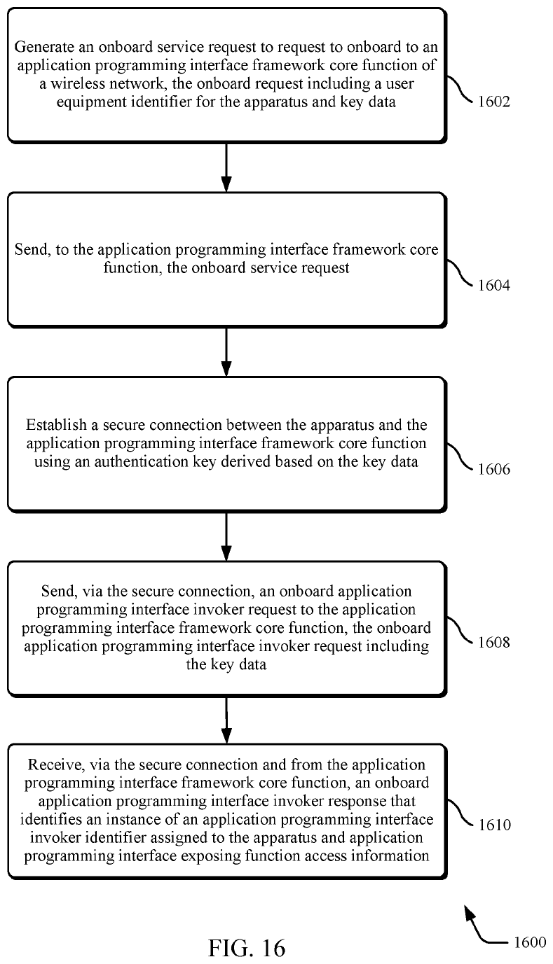

FIG. 16 illustrates a flowchart of a method 1600 that supports API access management in wireless systems in accordance with aspects of the present disclosure. The operations of the method 1600 may be implemented by a device or its components as described herein. For example, the operations of the method 1600 may be performed by a device, such as a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1602, the method may include generating an onboard service request to request to onboard to an application programming interface framework core function of a wireless network, the onboard request including a user equipment identifier for the apparatus and key data. The operations of 1602 may be performed in accordance with examples as described herein. In some implementations, aspects of the operations of 1602 may be performed by a device as described with reference to FIGS. 1 and 2.

At 1604, the method may include sending, to the application programming interface framework core function, the onboard service request. The operations of 1604 may be performed in accordance with examples as described herein. In some implementations, aspects of the operations of 1604 may be performed by a device as described with reference to FIG. 1.

At 1606, the method may include establishing a secure connection between the apparatus and the application programming interface framework core function using an authentication key derived based on the key data. The operations of 1606 may be performed in accordance with examples as described herein. In some implementations, aspects of the operations of 1606 may be performed by a device as described with reference to FIG. 1.

At 1608, the method may include sending, via the secure connection, an onboard application programming interface invoker request to the application programming interface framework core function, the onboard application programming interface invoker request including the key data. The operations of 1608 may be performed in accordance with examples as described herein. In some implementations, aspects of the operations of 1608 may be performed by a device as described with reference to FIG. 1.

At 1610, the method may include receiving, via the secure connection and from the application programming interface framework core function, an onboard application programming interface invoker response that identifies an instance of an application programming interface invoker identifier assigned to the apparatus and application programming interface exposing function access information. The operations of 1610 may be performed in accordance with examples as described herein. In some implementations, aspects of the operations of 1610 may be performed by a device as described with reference to FIG. 1.

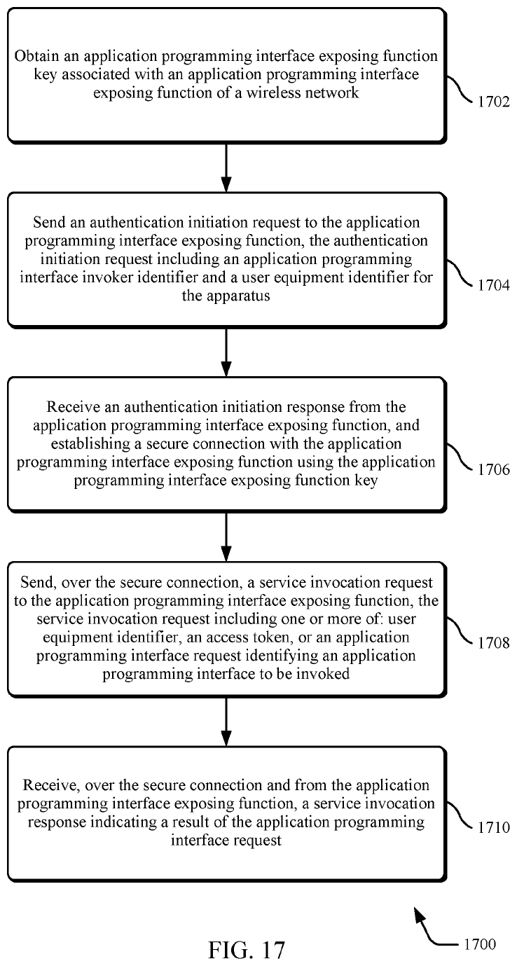

FIG. 17 illustrates a flowchart of a method 1700 that supports API access management in wireless systems in accordance with aspects of the present disclosure. The operations of the method 1700 may be implemented by a device or its components as described herein. For example, the operations of the method 1700 may be performed by a device, such as a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1702, the method may include obtaining an application programming interface exposing function key associated with an application programming interface exposing function of a wireless network. The operations of 1702 may be performed in accordance with examples as described herein. In some implementations, aspects of the operations of 1702 may be performed by a device as described with reference to FIGS. 1 and 2.

At 1704, the method may include sending an authentication initiation request to the application programming interface exposing function, the authentication initiation request including an application programming interface invoker identifier and a user equipment identifier for the apparatus. The operations of 1704 may be performed in accordance with examples as described herein. In some implementations, aspects of the operations of 1704 may be performed by a device as described with reference to FIG. 1.

At 1706, the method may include receiving an authentication initiation response from the application programming interface exposing function, and establishing a secure connection with the application programming interface exposing function using the application programming interface exposing function key. The operations of 1706 may be performed in accordance with examples as described herein. In some implementations, aspects of the operations of 1706 may be performed by a device as described with reference to FIG. 1.

At 1708, the method may include sending, over the secure connection, a service invocation request to the application programming interface exposing function, the service invocation request including one or more of: user equipment identifier, an access token, or an application programming interface request identifying an application programming interface to be invoked. The operations of 1708 may be performed in accordance with examples as described herein. In some implementations, aspects of the operations of 1708 may be performed by a device as described with reference to FIG. 1.

At 1710, the method may include receiving, over the secure connection and from the application programming interface exposing function, a service invocation response indicating a result of the application programming interface request. The operations of 1710 may be performed in accordance with examples as described herein. In some implementations, aspects of the operations of 1710 may be performed by a device as described with reference to FIG. 1.

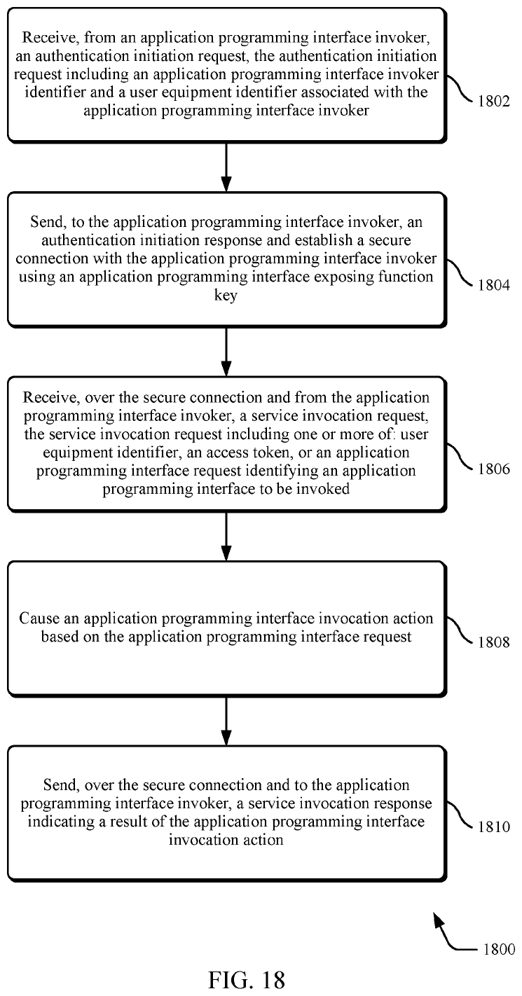

FIG. 18 illustrates a flowchart of a method 1800 that supports API access management in wireless systems in accordance with aspects of the present disclosure. The operations of the method 1800 may be implemented by a device or its components as described herein. For example, the operations of the method 1800 may be performed by a device, such as a component of the core network 106 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1802, the method may include receive, from an application programming interface invoker, an authentication initiation request, the authentication initiation request including an application programming interface invoker identifier and a user equipment identifier associated with the application programming interface invoker. The operations of 1802 may be performed in accordance with examples as described herein. In some implementations, aspects of the operations of 1802 may be performed by a device as described with reference to FIGS. 1 and 2.

At 1804, the method may include sending, to the application programming interface invoker, an authentication initiation response and establish a secure connection with the application programming interface invoker using an application programming interface exposing function key. The operations of 1804 may be performed in accordance with examples as described herein. In some implementations, aspects of the operations of 1804 may be performed by a device as described with reference to FIG. 1.

At 1806, the method may include receiving, over the secure connection and from the application programming interface invoker, a service invocation request, the service invocation request including one or more of: user equipment identifier, an access token, or an application programming interface request identifying an application programming interface to be invoked. The operations of 1806 may be performed in accordance with examples as described herein. In some implementations, aspects of the operations of 1806 may be performed by a device as described with reference to FIG. 1.

At 1808, the method may include causing an application programming interface invocation action based on the application programming interface request. The operations of 1808 may be performed in accordance with examples as described herein. In some implementations, aspects of the operations of 1808 may be performed by a device as described with reference to FIG. 1.

At 1810, the method may include sending, over the secure connection and to the application programming interface invoker, a service invocation response indicating a result of the application programming interface invocation action. The operations of 1810 may be performed in accordance with examples as described herein. In some implementations, aspects of the operations of 1810 may be performed by a device as described with reference to FIG. 1.

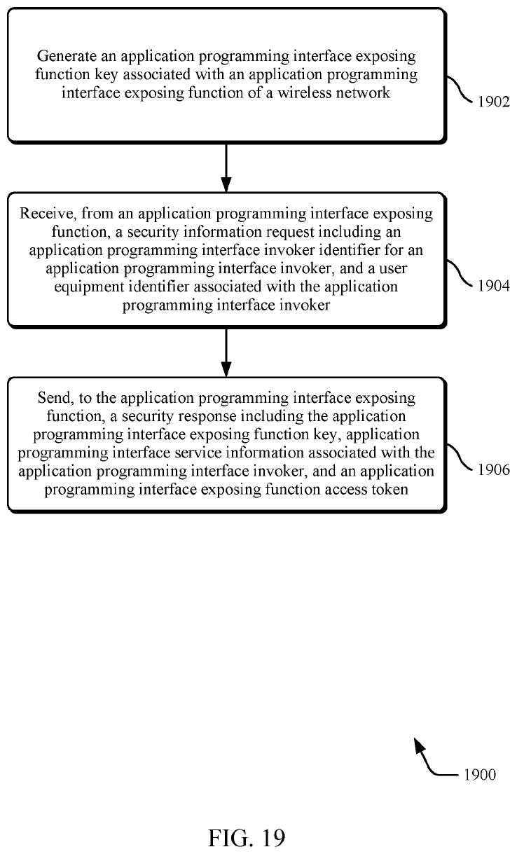

FIG. 19 illustrates a flowchart of a method 1900 that supports API access management in wireless systems in accordance with aspects of the present disclosure. The operations of the method 1900 may be implemented by a device or its components as described herein. For example, the operations of the method 1900 may be performed by a device, such as a component of the core network 106 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1902, the method may include generating an application programming interface exposing function key associated with an application programming interface exposing function of a wireless network. The operations of 1902 may be performed in accordance with examples as described herein. In some implementations, aspects of the operations of 1902 may be performed by a device as described with reference to FIGS. 1 and 2.

At 1904, the method may include receiving, from an application programming interface exposing function, a security information request including an application programming interface invoker identifier for an application programming interface invoker, and a user equipment identifier associated with the application programming interface invoker. The operations of 1904 may be performed in accordance with examples as described herein. In some implementations, aspects of the operations of 1904 may be performed by a device as described with reference to FIG. 1.

At 1906, the method may include sending, to the application programming interface exposing function, a security response including the application programming interface exposing function key, application programming interface service information associated with the application programming interface invoker, and an application programming interface exposing function access token. The operations of 1906 may be performed in accordance with examples as described herein. In some implementations, aspects of the operations of 1906 may be performed by a device as described with reference to FIG. 1.

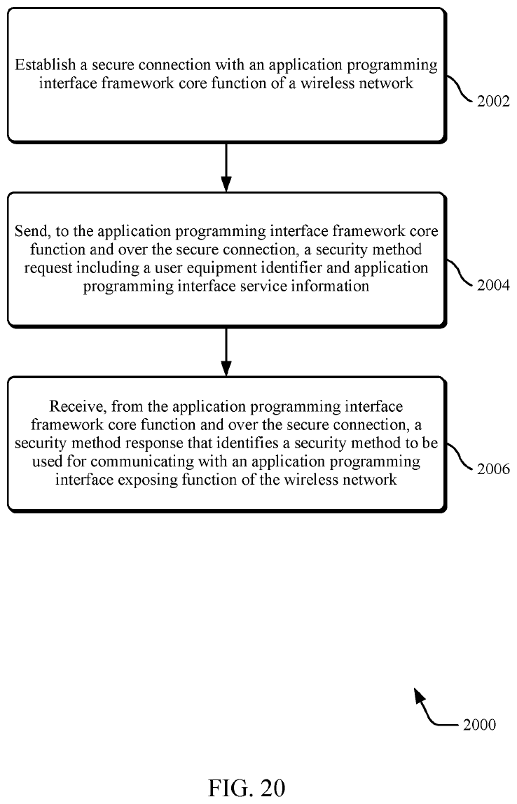

FIG. 20 illustrates a flowchart of a method 2000 that supports API access management in wireless systems in accordance with aspects of the present disclosure. The operations of the method 2000 may be implemented by a device or its components as described herein. For example, the operations of the method 2000 may be performed by a device, such as UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 2002, the method may include establishing a secure connection with an application programming interface framework core function of a wireless network. The operations of 2002 may be performed in accordance with examples as described herein. In some implementations, aspects of the operations of 2002 may be performed by a device as described with reference to FIGS. 1 and 2.

At 2004, the method may include sending, to the application programming interface framework core function and over the secure connection, a security method request including a user equipment identifier and application programming interface service information. The operations of 2004 may be performed in accordance with examples as described herein. In some implementations, aspects of the operations of 2004 may be performed by a device as described with reference to FIG. 1.

At 2006, the method may include receiving, from the application programming interface framework core function and over the secure connection, a security method response that identifies a security method to be used for communicating with an application programming interface exposing function of the wireless network. The operations of 2006 may be performed in accordance with examples as described herein. In some implementations, aspects of the operations of 2006 may be performed by a device as described with reference to FIG. 1.

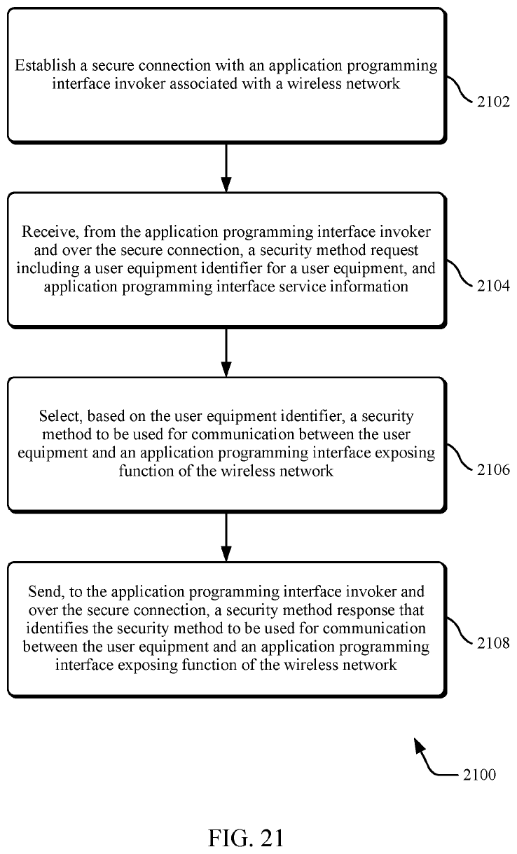

FIG. 21 illustrates a flowchart of a method 2100 that supports API access management in wireless systems in accordance with aspects of the present disclosure. The operations of the method 2100 may be implemented by a device or its components as described herein. For example, the operations of the method 2100 may be performed by a device, such as a component of the core network 106 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 2102, the method may include establishing a secure connection with an application programming interface invoker associated with a wireless network. The operations of 2102 may be performed in accordance with examples as described herein. In some implementations, aspects of the operations of 2102 may be performed by a device as described with reference to FIGS. 1 and 2.

At 2104, the method may include receiving, from the application programming interface invoker and over the secure connection, a security method request including a user equipment identifier for a user equipment, and application programming interface service information. The operations of 2104 may be performed in accordance with examples as described herein. In some implementations, aspects of the operations of 2104 may be performed by a device as described with reference to FIG. 1.

At 2106, the method may include selecting, based on the user equipment identifier, a security method to be used for communication between the user equipment and an application programming interface exposing function of the wireless network. The operations of 2106 may be performed in accordance with examples as described herein. In some implementations, aspects of the operations of 2106 may be performed by a device as described with reference to FIG. 1.

At 2108, the method may include sending, to the application programming interface invoker and over the secure connection, a security method response that identifies the security method to be used for communication between the user equipment and an application programming interface exposing function of the wireless network. The operations of 2108 may be performed in accordance with examples as described herein. In some implementations, aspects of the operations of 2108 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus comprising:
at least one memory; and
at least one processor coupled with the at least one memory and configured to cause the apparatus to:
generate a first request for onboarding with an application programming interface framework core function of a wireless network, the first request including a user equipment identifier for the apparatus;
send, to an application programming interface provider domain of the wireless network, the request;
receive a first response that includes enrollment data including key data associated with the application programming interface framework core function of a wireless network; and
store the enrollment data for use by the apparatus to perform an onboarding procedure for onboarding one or more of the apparatus or an application related to the apparatus with the application programming interface framework core function of the wireless network to enable the apparatus to invoke one or more application programming interfaces exposed by the application programming interface provider domain.

2. The apparatus of claim 1, wherein the apparatus comprises one or more of a user equipment or a network apparatus that interfaces with the user equipment, and wherein the onboarding procedure is for onboarding an application programming interface invoker of the user equipment, the application programming interface invoker comprising one or more of the application residing on the user equipment, or an application function residing external to the user equipment.

3. The apparatus of claim 1, wherein the first request comprises an access token request, and wherein to generate the first request further comprises to generate the first request to include one or more of an application identifier for an application that resides on the apparatus, an application function identifier for the application that resides on the apparatus, an identifier for an application function external to the apparatus, or user consent information indicating user consent to onboard with the application programming interface framework core function.

4. The apparatus of claim 1, wherein the user equipment identifier for the apparatus includes one or more of a generic public subscription identifier for the apparatus, a user equipment internet protocols address for the apparatus, an ethernet address for the apparatus, an external group identifier for the apparatus, or an application programming interface framework apparatus identifier for the apparatus.

5. The apparatus of claim 1, wherein the enrollment data further includes one or more of an indication that the apparatus is successful enrolled for onboarding with the application programming interface framework core function, an authentication key, key data identifier, an application programming function provider domain function identifier, an application programming interface framework core function identifier, an application programming interface framework core function address, an application identifier, an application function identifier, or an access token.

6. The apparatus of claim 1, wherein the key data comprises one or more of an application programming interface framework core function key, an application programming interface framework core function key identifier, or an application programming interface exposing function key.

7. The apparatus of claim 1, wherein the at least one processor is further configured to cause the apparatus to:
generate a second request to request to onboard to the application programming interface framework core function of the wireless network, the second request including the user equipment identifier for the apparatus and a key identifier;
send, to the application programming interface framework core function, the second request;
establish a secure connection between the apparatus and the application programming interface framework core function using an authentication key derived based on the key data;
send, via the secure connection, an onboard application programming interface invoker request to the application programming interface framework core function, the onboard application programming interface invoker request including the key identifier; and
receive, via the secure connection and from the application programming interface framework core function, an onboard application programming interface invoker response that identifies an instance of an application programming interface invoker identifier assigned to the apparatus and application programming interface exposing function access information.

8. The apparatus of claim 7, wherein:
the second request further includes one or more of an onboarding type for the second request, an application identifier for an application of the apparatus, an application identifier for the application of the apparatus, an application function identifier for an application of the apparatus, an identifier for an application function external to the apparatus, an application programming interface provider domain identifier or an application programming interface exposing function identifier; and
the onboard application programming interface invoker request further includes one or more of an onboarding type, an application identifier for an application of the apparatus, an application function identifier for an application of the apparatus, an identifier for an application function external to the apparatus, or an access token.

9. The apparatus of claim 7, wherein the application programming interface exposing function access information comprises one or more of an application programming interface exposing function access token, an application programming interface exposing function onboard secret, an application programming interface framework core function access token, or an application programming interface exposing function key.

10. The apparatus of claim 7, wherein the application programming interface exposing function access information comprises an input parameter for use by the apparatus to generate an application programming interface exposing function key for enabling access to the application programming interface exposing function.

11. The apparatus of claim 7, wherein to establish the secure connection between the apparatus and the application programming interface framework core function comprises to establish a secure connection using a key derived based on the key data.

12. An apparatus comprising:
at least one memory; and
at least one processor coupled with the at least one memory and configured to cause the apparatus to:
receive, from an application programming interface invoker, a first request requesting enrollment for onboarding with an application programming interface framework core function of a wireless network, the first request including a user equipment identifier for the application programming interface invoker;
send, to an authentication function of the wireless network, an authentication/authorization request that includes the user equipment identifier and an application programming interface framework core function identifier for the application programming interface framework core function of the wireless network;
receive, from the authentication function, an authentication/authorization response including key data for the application programming interface framework core function of the wireless network; and
send, to the application programming interface invoker, a first response that includes an indication that the application programming interface invoker is successfully enrolled for onboarding with the application programming interface framework core function of the wireless network, a key data identifier, and the key data for the application programming interface framework core function of the wireless network.

13. The apparatus of claim 12, wherein the first request comprises an access token request, and wherein the first request further includes one or more of an application identifier for an application of the application programming interface invoker, an application function identifier for an application of the application programming interface invoker, or user consent information, and wherein the authentication/authorization request further includes the one or more of the application identifier for an application of the application programming interface invoker, the application function identifier for the application of the application programming interface invoker, or the user consent information.

14. The apparatus of claim 12, wherein the at least one processor is further configured to cause the apparatus to:
generate an access token that enables access to the application programming interface managed by the application programming interface framework core function, wherein the access token is generated based at least in part on one or more of a user equipment identifier, a generic public description identifier for the apparatus, an application programming interface domain identifier, a common application programming interface framework identifier, an application identifier, an application function identifier, or service authorization information or a list that indicates a type of service allowed for the application programming interface invoker; and
include the access token in the response.

15. The apparatus of claim 12, wherein the at least one processor is further configured to cause the apparatus to:
generate, using the key data, a key that enables secure interaction with the application programming interface framework core function; and
include the key in the response.

16. The apparatus of claim 12, wherein the at least one processor is further configured to cause the apparatus to:
receive, from the application programming interface framework core function and based on an onboard service request from the application programming interface invoker, a request for the key data; and
send, to the application programming interface framework core function, the key data.

17. An apparatus comprising:
at least one memory; and
at least one processor coupled with the at least one memory and configured to cause the apparatus to:
receive an authentication/authorization request for authenticating/authorizing an application programming interface invoker to onboard with an application programming interface framework core function of a wireless network, the authentication/authorization request including a user equipment identifier for the application programming interface invoker and an application programming interface framework core function identifier for the application programming interface framework core function of the wireless network;
derive, based on the application programming interface framework core function identifier, key data for the application programming interface framework core function of the wireless network;
generate an authentication/authorization response that indicates that the application programming interface invoker is authorized for onboarding with the application programming interface framework core function of the wireless network and that includes the key data for the application programming interface framework core function of the wireless network; and
send, to an application programming interface provider domain of the wireless network, the authentication/authorization response.

18. The apparatus of claim 17, wherein the at least one processor is further configured to cause the apparatus to determine whether a user equipment associated with the application programming interface invoker is authenticated for onboarding with the application programming interface framework core function, and to generate the authentication/authorization response based on to determine that the user equipment associated with the application programming interface invoker is authenticated for onboarding with the application programming interface framework core function.

19. (canceled)

20. (canceled)

21. An apparatus comprising:
at least one memory; and
at least one processor coupled with the at least one memory and configured to cause the apparatus to:
receive, from an application programming interface invoker, a request including an onboard credential for the application programming interface invoker;
perform one or more operations to check if a user equipment has given prior consent information related to allowing the application programming interface invoker to consume a service application programming interface invocation related to the user equipment;
generate an application programming interface invoker profile comprising a selected method for application programming interface exposing function authentication and authorization between the application programming interface invoker and an application programming interface exposing function;
generate an application programming interface exposing function access token for an assigned application programming interface invoker identity, the application programming interface exposing function access token configured for establishing a secure connection and authentication with the application programming interface exposing function; and
send, to the application programming interface invoker, a response comprising the application programming interface exposing function access token.

22. The apparatus of claim 21, wherein the request comprises an access token request, and wherein the at least one processor is further configured to cause the apparatus to generate the application programming interface exposing function access token based at least in part on one or more of a generic public description identifier for the apparatus, an application programming interface invoker identifier, a common application programming interface framework core function identifier, an application programming interface exposing function identifier, or application programming interface exposing function information.
